(19) United States
(12) Patent Application Publication
(10) Pub. No.: US 2026/0095881 A1
(43) Pub. Date: Apr. 2, 2026

(54) COMBINED ONE-TO-MANY AND MANY-TO-ONE SIDELINK POSITIONING

(71) Applicant: Lenovo (Singapore) Pte. Limited, Singapore (SG)

(72) Inventors: Robin Rajan Thomas, Bad Nauheim (DE); Karthikeyan Ganesan, Nauheim (DE); Abir Ben Hadj Fredj, Wiesbaden (DE)

(73) Assignee: Lenovo (Singapore) Pte. Limited, Singapore (SG)

(21) Appl. No.: 19/111,446

(22) PCT Filed: Oct. 9, 2023
(86) PCT No.: PCT/IB2023/060113

§ 371 Date: Mar. 13, 2025

Related U.S. Application Data
(60) Provisional application No. 63/419,304, filed on Oct. 25, 2022.

(51) Int. Cl. H04W 64/00; H04W 24/10; H04W 72/25

(52) U.S. Cl. CPC H04W 64/00; H04W 24/10; H04W 72/25

(57) ABSTRACT

Various aspects of the present disclosure relate to performing one-to-many and many-to-one sidelink positioning, such as using sidelink time difference of arrival (SL-TDoA) and sidelink round trip time (SL-RTT) positioning techniques in a single sidelink positioning session. Positioning measurements for a particular device (e.g., a target UE) are generated by both the particular device and a set of additional devices, and these positioning measurements are provided to a positioning calculation entity that can estimate the location of the particular device.

### RELATED APPLICATION

This application claims priority to U.S. Patent Application Ser. No. 63/419,304 filed Oct. 25, 2022 entitled “COMBINED ONE-TO-MANY AND MANY-TO-ONE SIDELINK POSITIONING,” the disclosure of which is incorporated by reference herein in its entirety.

### TECHNICAL FIELD

The present disclosure relates to wireless communications, and more specifically to one-to-many and many-to-one sidelink positioning.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Various applications that may run on a UE or on a network entity may desire to know the location of the UE. However, as the UEs may be mobile, the locations of the UEs may vary over time. Accordingly, positioning reference signals (PRSs) may be used to determine the location or position of a UE.

### SUMMARY

The present disclosure relates to methods, apparatuses, and systems that support combined one-to-many and many-to-one sidelink positioning. Sidelink refers to wireless communication by one UE directly with another, such as over a device-to-device communication link. Sidelink positioning refers to generating positioning measurements using sidelink to be used in estimating the position of a device. This position may be an absolute position, a relative position with respect to another UE/network entity, a distance with respect to another UE/network entity, a direction with respect to another UE/network entity, or a combination thereof. The techniques discussed herein perform one-to-many and many-to-one sidelink positioning, such as using sidelink time difference of arrival (SL-TDoA) and sidelink round trip time (SL-RTT) positioning techniques in a single sidelink positioning session. Positioning measurements for a target UE are generated by both the target UE and the anchor UEs, and these positioning measurements are provided to a positioning calculation entity that can estimate the location (position) of the target UE. By combining one-to-many and many-to-one sidelink positioning into a single session a position estimate of a device (e.g., a UE) may be determined efficiently and quickly.

Some implementations of the method and apparatuses described herein may further include receiving, from a first set of devices, first signalings indicating a first set of sidelink positioning reference signals (SL-PRSs) transmitted in a many-to-one manner; generating a first set of positioning measurements based on the first set of SL-PRSs; transmitting, to the first set of devices in response to the receiving the first set of SL-PRSs, second signalings indicating an additional sidelink positioning reference signal (SL-PRS) in a one-to-many manner; receiving, from the first set of devices, third signalings indicating a second set of positioning measurements; transmitting a fourth signaling indicating a measurement report including the first set of positioning measurements and the second set of positioning measurements.

In some implementations of the method and apparatuses described herein, the method and apparatuses may further include transmitting, to the first set of devices in response to receiving the first set of SL-PRSs, fifth signalings indicating a SL-PRS measurement report. Additionally or alternatively, the apparatus comprises a target UE and the first set of devices comprises one or more of an anchor UE, a sidelink positioning server UE, and a roadside unit. Additionally or alternatively, each positioning measurement in the first set of positioning measurements and the second set of positioning measures comprises one or more of a sidelink reference signal time difference, a sidelink relative time of arrival, a user equipment receive-transmit time difference, a sidelink angle-of-arrival, a sidelink reference signal received power, and a sidelink reference signal received path power. Additionally or alternatively, the sidelink reference signal time difference measurement is defined as a sidelink relative timing difference between a transmission point (TP) of an anchor device j and a reference TP of an anchor device i, defined as T_{SubframeRx,j}−T_{SubframeRx,i}, where: the T_{SubframeRx,j} is a time when the user equipment receives a start of one subframe from the TP of the anchor device j and the T_{SubframeRx,i} is a time when the user equipment receives a corresponding start of one subframe from the TP of the anchor device i that is closest in time to a subframe received from the TP of anchor device j. Additionally or alternatively, the sidelink relative time of arrival measurement is defined as a beginning of a sidelink subframe i containing SL-PRS resources received at each of the first set of devices, relative to a sidelink relative time of arrival (SL-RTOA) reference time, the SL-RTOA reference time further defined by T₀+t_{SL-PRS}, where T₀ is a nominal start time of a system frame number (SFN) 0 or a direct frame number (DFN) 0 and t_{SL-PRS} is defined by (10n_{SL-F}+n_{SL-SF})×10⁻³, where n_{SL-F} and n_{SL-SF} represent the DFN and subframe number of the SL-PRS resources, respectively. Additionally or alternatively, the user equipment receive-transmit time difference measurement is defined as a difference between a reception time of a SL-PRS and subsequent transmission time of another SL-PRS, defined by T_{UE-RX}−T_{UE-TX}, where the T_{UE-RX} is the user equipment received timing of a sidelink subframe #i from a sidelink device, defined by a first detected path in time and the T_{UE-TX} is defined as the user equipment transmit timing of a sidelink subframe #j that is closest in time to the subframe #i received from the sidelink device. Additionally or alternatively, the method and apparatuses may further include receiving a fifth signaling indicating a configuration message to perform one-to-many SL-PRS transmission and many-to-one SL-PRS reception. Additionally or alternatively, the configuration message comprises one or more of a sidelink positioning protocol message, a sidelink control information, a sidelink medium access control element, a PC5-RRC message, a PC5-S message, a vehicle-to-everything message, and a proximity services layer message. Additionally or alternatively, the configuration message comprises a trigger including a SL-PRS cast type indicator indicating a transmission type for SL-PRS via 1st stage or 2nd stage sidelink control information (SCI), a transmission order of the SL-PRS, and a type of positioning technique to be performed. Additionally or alternatively, the SL-PRS cast type indicator comprises one of a unicast, groupcast, one-to-many, many-to-one, or broadcast indication. Additionally or alternatively, the one-to-many or many-to-one indication comprise a plurality of separate unicast signalings. Additionally or alternatively, a triggering message to perform sidelink positioning comprises one or more of: a number of identified anchor devices, types of positioning methods, a transmission order indication of SL-PRS, user equipment identifiers of involved user equipments in a configured sidelink positioning session, cast-type indicators, an indication of a configured reference anchor device, synchronization information. Additionally or alternatively, transmitting the second signalings includes transmitting the second signalings in an order of transmission comprises first transmitting a first SL-PRS in a one-to-many manner and thereafter transmitting additional SL-PRSs in a many-to-one manner. Additionally or alternatively, the method and apparatuses may further include transmitting the fourth signaling to one or more of a base station, a location management function, a roadside unit, a sidelink positioning server user equipment, and a sidelink positioning client user equipment. Additionally or alternatively, the method and apparatuses may further include receiving a fifth signaling indicating a reference anchor device for generating the first set of positioning measurements, wherein the reference anchor device is one of the first set of devices. Additionally or alternatively, the method and apparatuses may further include wherein the fifth signaling further indicates a SL-PRS identifier allowing a particular SL-PRS resource to be identified, a subframe boundary offset at a location of the anchor device between the reference anchor device and an additional device in the first set of devices, and a quality of real time difference between the reference anchor device and the additional device in the first set of devices.

Some implementations of the method and apparatuses described herein may further include transmitting, to a first device in a many-to-one manner, a first signaling indicating a first SL-PRS; receiving, from the first device in a one-to-many manner in response to the first SL-PRS, a second signaling indicating a second SL-PRS; generating a first positioning measurement based on the second SL-PRS; transmitting a third signaling indicating a third SL-PRS or a measurement report including the first positioning measurement.

In some implementations of the method and apparatuses described herein, the method and apparatuses may further include receiving, from the first device, a fourth signaling indicating a SL-PRS measurement report. Additionally or alternatively, the first device comprises a target UE and the apparatus comprises one or more of an anchor UE, a sidelink positioning server UE, and a roadside unit. Additionally or alternatively, the first positioning measurement comprises one or more of a sidelink reference signal time difference, a sidelink relative time of arrival, a user equipment receive-transmit time difference, a sidelink angle-of-arrival, a sidelink reference signal received power, and a sidelink reference signal received path power. Additionally or alternatively, the method and apparatuses described herein, the method and apparatuses may further include receiving a fourth signaling indicating a configuration message to perform one-to-many SL-PRS reception and many-to-one SL-PRS transmission. Additionally or alternatively, the configuration message comprises one or more of a sidelink control information (SCI), sidelink medium access control element (SL MAC CE), sidelink positioning protocol message, a PC5-RRC message, a PC5-S message, a vehicle-to-everything message, and a proximity services layer message. Additionally or alternatively, the configuration message comprises a trigger including a SL-PRS cast type indicator indicating a transmission type for SL-PRS via 1st stage or 2nd stage sidelink control information (SCI), a transmission order of the SL-PRS, and a type of positioning technique to be performed. Additionally or alternatively, the SL-PRS cast type indicator comprises one of a unicast, groupcast, one-to-many, many-to-one, or broadcast indication. Additionally or alternatively, the method and apparatuses described herein, the method and apparatuses may further include transmitting the third signaling to one or more of a base station, a location management function, a roadside unit, a sidelink positioning server user equipment, a sidelink positioning client user equipment, and the first device. Additionally or alternatively, the method and apparatuses described herein, the method and apparatuses may further include receiving a fourth signaling indicating that the apparatus is a reference anchor for the first device to generate a set of positioning measurements. Additionally or alternatively, the method and apparatuses described herein, the method and apparatuses may further include receiving a fourth signaling indicating one or both of a search window or a search window quality indicator in which to expect the second signaling.

### BRIEF DESCRIPTION OF THE DRAWINGS

FIG. 1 illustrates an example of a wireless communications system that supports combined one-to-many and many-to-one sidelink positioning in accordance with aspects of the present disclosure.

FIG. 2 illustrates an example of a system of NR beam-based positioning as related to combined one-to-many and many-to-one sidelink positioning in accordance with aspects of the present disclosure.

FIG. 3 illustrates an example of absolute and relative positioning scenarios as related to combined one-to-many and many-to-one sidelink positioning in accordance with aspects of the present disclosure.

FIG. 4 illustrates an example of a multi-cell RTT procedure as related to combined one-to-many and many-to-one sidelink positioning in accordance with aspects of the present disclosure.

FIG. 5 illustrates an example of a system for existing relative range estimation as related to combined one-to-many and many-to-one sidelink positioning in accordance with aspects of the present disclosure.

FIG. 6 illustrates an example of a system using many-to-one SL-TDoA as related to combined one-to-many and many-to-one sidelink positioning in accordance with aspects of the present disclosure.

FIG. 7 illustrates an example of a system using one-to-many SL-TDoA as related to combined one-to-many and many-to-one sidelink positioning in accordance with aspects of the present disclosure.

FIG. 8 illustrates an example of a system using combined one-to-many and many-to-one SL-TDoA as related to combined one-to-many and many-to-one sidelink positioning in accordance with aspects of the present disclosure.

FIG. 9 illustrates an example of a system using SL-RTT as related to combined one-to-many and many-to-one sidelink positioning in accordance with aspects of the present disclosure.

FIG. 10 illustrates an example of a SL-RTD information message as related to combined one-to-many and many-to-one sidelink positioning in accordance with aspects of the present disclosure.

FIG. 11 illustrates an example of a SL-PRS configuration message as related to combined one-to-many and many-to-one sidelink positioning in accordance with aspects of the present disclosure.

FIGS. 12 and 13 illustrate an example of a block diagram of a device that supports combined one-to-many and many-to-one sidelink positioning in accordance with aspects of the present disclosure.

FIGS. 14 through 18 illustrate flowcharts of methods that support combined one-to-many and many-to-one sidelink positioning in accordance with aspects of the present disclosure.

### DETAILED DESCRIPTION

Various different sidelink positioning techniques may be used to obtain good sidelink positioning performance, such as good accuracy and/or low latency positioning. Examples of such sidelink positioning techniques include SL-TDoA, where one-to-many and many-to-one sidelink positioning reference signal (SL-PRS) transmissions may be used to achieve good absolute positioning performance, and or SL-RTT where one-to-many and many-to-one SL-PRS transmissions may be used to achieve good relative positioning. Many-to-one refers to multiple devices transmitting to a single device (e.g., multiple anchor UEs sending SL-PRSs to a target UE). One-to-many refers to a single device transmitting to multiple devices (e.g., a single target UE sending SL-PRSs to multiple anchor UEs).

Using the techniques discussed herein, both one-to-many and many-to-one transmissions are used as part of a single sidelink positioning session. A sidelink positioning session refers to transmissions between devices (e.g., a target UE and multiple anchor UEs) of SL-PRSs that are measured at the devices and other related sidelink positioning messages, e.g., SL-PRS configuration exchange (sidelink positioning assistance data), sidelink positioning measurement/location report, sidelink positioning capability exchange, sidelink positioning abort/error exchange and made available to a position calculation entity.

In one or more implementations, a target UE receives a first set of SL-PRSs transmitted in a many-to-one manner from a set of anchor UEs, and generates a first set of positioning measurements for the target UE based on the first set of SL-PRSs. The target UE transmits, in response to receiving the first set of SL-PRSs, an additional SL-PRS in a one-to-many manner to the set of anchor UEs. The target UE then receives a second set of positioning measurements for the target UE from the SL-PRSs, and transmits a measurement report including the first set of positioning measurements and the second set of positioning measurements to a positioning calculation entity, which can use the measurement report to generate a position estimate for the target UE.

The techniques discussed herein provide an efficient solution to performing one-to-many and many-to-one sidelink positioning and combines measurement reporting of the sidelink positioning techniques. For example, the combined use of both sidelink reference signal time difference (SL-RSTD) for SL-TDoA and sidelink relative time of arrival (SL-RTOA) for SL-TDoA, and two UE receive (RX or Rx)-transmit (TX or Tx) time difference measurements for SL-RTT results in better performance when estimating positions compared to using only one many-to-one SL-TDoA/SL-RTT or only one-to-many SL-TDoA/SL-RTT.

Furthermore, the techniques discussed herein enhance selection of a reference anchor node when using SL-RSTD. Sidelink real time difference (RTD) information, including synchronization information, may also be passed between the reference anchor node and other anchor nodes to enable accurate SL-RSTD measurements and compensate for any synchronization-related errors.

Additionally, the techniques discussed herein enable the anchor nodes to receive assistance information in terms of an expected search window and associated uncertainty to perform the SL-RTOA measurements.

Performing one-to-many and many-to-one SL-TDoA (or SL-RTT) as two separate procedures may be considered inefficient and increase the delay required to obtain a positioning estimate, where positioning delay should be minimized to best extent possible, especially in safety critical applications such as V2X, IIoT, etc. The techniques discussed herein combine one-to-many and many-to-one sidelink positioning into a single session, allowing a position estimate of a device (e.g., a UE) to be determined more efficiently and more quickly than performing two separate procedures. The accuracy of the positioning estimate may also be improved by using both SL-TDoA and SL-RTT rather than using only one of SL-TDoA and SL-RTT.

Aspects of the present disclosure are described in the context of a wireless communications system. Aspects of the present disclosure are further illustrated and described with reference to device diagrams and flowcharts.

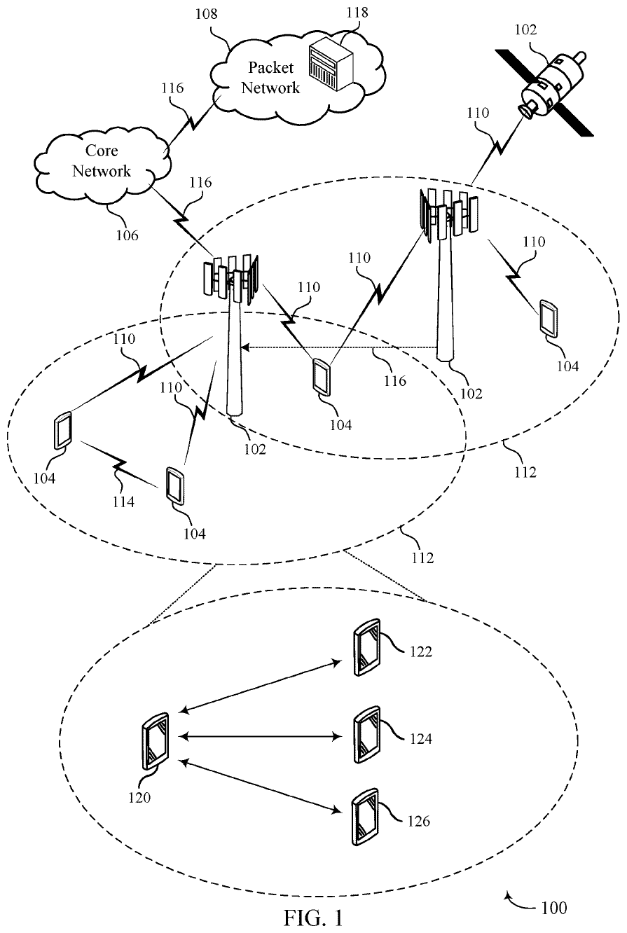

FIG. 1 illustrates an example of a wireless communications system 100 that supports combined one-to-many and many-to-one sidelink positioning in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), a location management function (LMF), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FRI may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The techniques discussed herein support efficient UE-to-UE range or orientation determination, which may be used to support absolute and relative positioning applications in various situations, such as across different vertical services (e.g., V2X, public safety, industrial Internet of things (IIoT), commercial services, and so forth). For example, the techniques discussed herein allow one or both of the absolute position and the relative position of a UE 120 (which may also be referred to as a target UE) to be determined based on SL-PRS transmissions between the UE 120 and each of UEs 122, 124, and 126 (each of which may also be referred to as an anchor UE). Each of the UEs 120, 122, 124, and 126 may be a UE 104 as discussed herein.

Sidelink positioning may support a variety of RAT-dependent positioning techniques including but not limited to SL-TDoA, SL-RTT, AL-AoA, and so forth. Each of these sidelink positioning techniques may involve a set of distributed UEs participating in a sidelink positioning session, which may be in-coverage, partial coverage and out-of-coverage. Techniques such as SL-TDoA use precise synchronization among sidelink nodes in order for the target UE to accurately perform RSTD measurements. Conversely, when the target UE transmits SL-PRS, the responder sidelink nodes are expected to accurately measure the RTOA of SL-PRS. This involves a degree of coordination amongst UEs within a sidelink positioning group, which involves one-to-many and many-to-one transmissions. Similarly, in the case of SL-RTT, single-sided and double-sided RTT can also be efficiently performed using one-to-many and many-to-one transmissions. Furthermore, a mechanism is used in order seamlessly support one-to-many, many-to-one or both one-to-many and, many-to-one SL-TDoA, SL-RTT and other positioning techniques in a single sidelink positioning session.

The techniques discussed herein describe systems, apparatuses and methods for enhanced sidelink mechanisms and procedures to enable one-to-many sidelink (SL) and many-to-one positioning in an efficient manner and address one or more of the following: efficiently supporting the different SL-TDoA variants and SL-RTT variants within a single SL positioning session including the support of a target UE to receive a trigger to perform sidelink positioning in a one-to-many and many-to-one fashion; supporting of reference anchor UE/node selection, which assists in enhancing the SL-RSTD measurement and tracking of synchronization errors; and supporting of anchor UEs to accurately measure the RTOA within a time window.

Communication between devices discussed herein, such as between UEs 120, 122, 124, and 126, communication between UEs and network entities 102, and so forth is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of radio resource control (RRC), downlink control information (DCI), uplink control information (UCI), SCI, medium access control element (MAC-CE), sidelink positioning protocol (SLPP), PC5 radio resource control (PC5-RRC) and so forth.

NR positioning based on NR Uu signals and SA architecture (e.g., beam-based transmissions) was first specified in Release 16. The targeted use cases also included commercial and regulatory (emergency services) scenarios as in Release 15. The performance requirements are the following:

| Positioning Error | Indoor | Outdoor |
|---|---|---|
| Horizontal | <3 m for 80% of UEs | <10 m for 80% of UEs |
| Positioning | | |
| Vertical Positioning | <3 m for 80% of UEs | <3 m for 80% of UEs |

Current 3GPP Release 17 Positioning has defined the positioning performance requirements for Commercial and IIoT use cases as follows:

| Positioning Error | Commercial | IIoT |
|---|---|---|
| Horizontal Positioning | (<1 m) for 90% | (<0.2 m) for 90% |
| | of UEs | of UEs; |
| Vertical Positioning | (<3 m) for 90% | (<1 m) for 90% |
| | of UEs | of UEs |
| Physical layer latency | (<10 ms) | (<10 ms) |
| for position estimation | | |
| of UE | | |
| End-to-End Latency | (<100 ms) | (<100 ms, in the |
| for position estimation | | order of 10 ms |
| of UE | | is desired) |

The supported positioning techniques in Release 16 are listed in Table 1.

TABLE 1
Supported Rel-16 UE positioning methods

| | | UE- | NG-RAN | |
|---|---|---|---|---|
| | UE- | assisted, | node | |
| Method | based | LMF-based | assisted | SUPL |
| A-GNSS | Yes | Yes | No | Yes (UE-based |
| | | | | and UE-assisted) |
| OTDOA ^{Note1, Note 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{NOTE1}:
This includes terrestrial beacon system (TBS) positioning based on PRS signals.
^{NOTE 2}:
In this version of the specification only observed time difference of arrival (OTDOA) based on LTE signals is supported.
^{NOTE 4}:
This includes Cell-ID for NR method.
^{NOTE 5}:
In this version of the specification only for TBS positioning based on MBS signals.

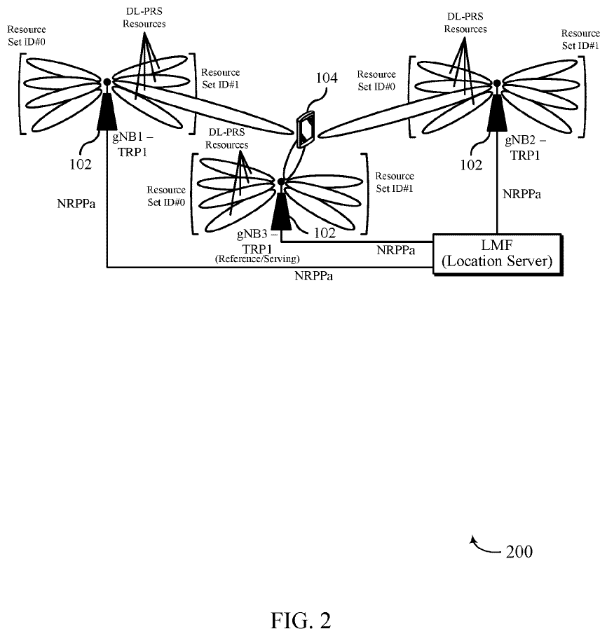

Separate positioning techniques as indicated in Table 1 can be currently configured and performed based on the requirements of the LMF and UE capabilities. The transmission of Uu (uplink and downlink) positioning reference signals (PRS) enable the UE to perform UE positioning-related measurements to enable the computation of a UE's absolute location estimate and are configured per transmission reception point (TRP), where a TRP may include a set of one or more beams. A conceptual overview is illustrated in FIG. 2.

FIG. 2 illustrates an example of a system 200 of NR beam-based positioning as related to combined one-to-many and many-to-one sidelink positioning in accordance with aspects of the present disclosure. The system 200 illustrates a UE 104 and network entities 102 (e.g., gNBs). The PRS can be transmitted by different base stations (serving and neighboring) using narrow beams over FR1 and FR2 as illustrated in the example system 200, which is relatively different when compared to LTE where the PRS was transmitted across the whole cell. The PRS can be locally associated with a PRS Resource identifier (ID) and Resource Set ID for a base station (TRP). Similarly, UE positioning measurements such as reference signal time difference (RSTD) and PRS reference signal received power (RSRP) measurements are made between beams (e.g., between a different pair of downlink (DL) PRS resources or DL PRS resource sets) as opposed to different cells as was the case in LTE. In addition, there are additional uplink (UL) positioning methods for the network to exploit in order to compute the target UE's location.

Tables 2 and 3 show the reference signal to measurements mapping for each of the supported RAT-dependent positioning techniques at the UE and gNB, respectively. The RAT-dependent positioning techniques may utilize the 3GPP RAT and core network entities to perform the position estimation of the UE, which are differentiated from RAT-independent positioning techniques, which rely on global navigation satellite system (GNSS), inertial measurement unit (IMU) sensor, WLAN, and Bluetooth technologies for performing target device (UE) positioning.

TABLE 2
UE Measurements to enable RAT-dependent
positioning techniques

| | | To facilitate support |
|---|---|---|
| DL/UL | | of the following |
| Reference | UE | positioning |
| Signals | Measurements | techniques |
| Rel. 16 DL PRS | DL RSTD | DL-TDOA |
| Rel. 16 DL PRS | DL PRS RSRP | DL-TDOA, DL-AoD, |
| | | Multi-RTT |
| Rel. 16 DL PRS/ | UE Rx-Tx time | Multi-RTT |
| Rel. 16 SRS for | difference | |
| positioning | | |
| Rel. 15 SSB/CSI-RS | SS-RSRP(RSRP for | E-CID |
| for RRM | RRM), SS-RSRQ(for | |
| | RRM), CSI-RSRP (for | |
| | RRM), CSI-RSRQ (for | |
| | RRM), SS-RSRPB | |
| | (for RRM) | |

TABLE 3
gNB Measurements to enable RAT-
dependent positioning techniques

| | | To facilitate support |
|---|---|---|
| DL/UL | | of the following |
| Reference | gNB | positioning |
| Signals | Measurements | techniques |
| Rel. 16 SRS for | UL RTOA | UL-TDOA |
| positioning | | |
| Rel. 16 SRS for | UL SRS-RSRP | UL-TDOA, UL-AoA, |
| positioning | | Multi-RTT |
| Rel. 16 SRS for | gNB Rx-Tx time | Multi-RTT |
| positioning, Rel. 16 | difference | |
| DL PRS | | |
| Rel. 16 SRS for | AoA and ZoA | UL-AoA, Multi-RTT |
| positioning, | | |

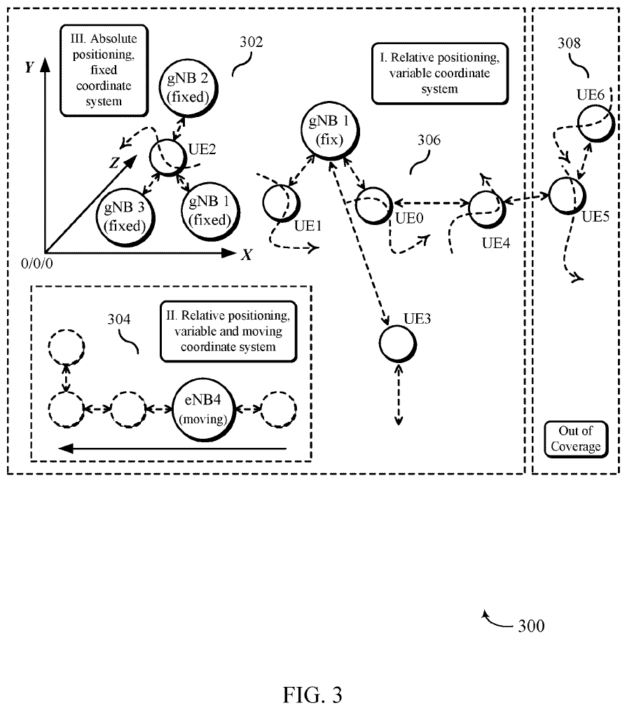

FIG. 3 illustrates an example 300 of absolute and relative positioning scenarios as related to combined one-to-many and many-to-one sidelink positioning in accordance with aspects of the present disclosure. The network devices described with reference to example 300 may use and/or be implemented with the wireless communications system 100 and include UEs 104 and network entities 102 (e.g., eNB, gNB). The example 300 is an overview of absolute and relative positioning scenarios as defined in the architectural (stage 1) specifications using three different co-ordinate systems, including (III) a conventional absolute positioning, fixed coordinate system at 302; (II) a relative positioning, variable and moving coordinate system at 304; and (I) a relative positioning, variable coordinate system at 306. Notably, the relative positioning, variable coordinate system at 306 is based on relative device positions in a variable coordinate system, where the reference may be always changing with the multiple nodes that are moving in different directions. The example 300 also includes a scenario 308 for an out of coverage area in which UEs need to determine relative position with respect to each other.

The relative positioning, variable and moving coordinate system at 304 may support relative lateral position accuracy of 0.1 meters between UEs supporting V2X applications, and may support relative longitudinal position accuracy of less than 0.5 meters for UEs supporting V2X applications for platooning in proximity. The relative positioning, variable coordinate system at 306 may support relative positioning between one UE and positioning nodes within 10 meters of each other. The relative positioning, variable coordinate system at 306 may also support vertical location of a UE in terms of relative height/depth to local ground level.

Various RAT-dependent positioning techniques are supported in Release 16 and Release 17, such as DL-TDoA, DL-AoD, Multi-RTT, E-CID/NR E-CID, UL-TDoA, and UL-AoA.

The DL-TDOA positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

The Multi-RTT positioning method makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE.

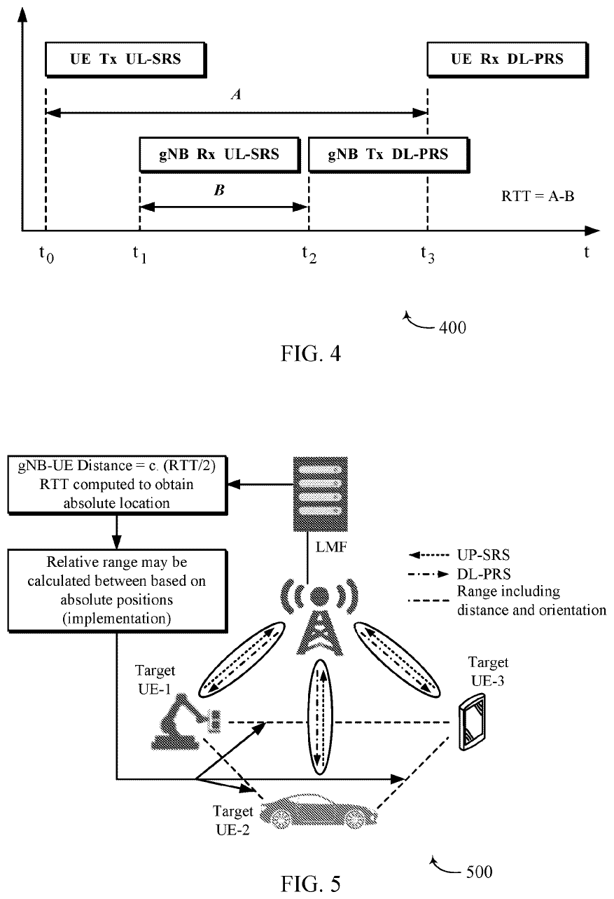

FIG. 4 illustrates an example 400 of a multi-cell RTT procedure as related to combined one-to-many and many-to-one sidelink positioning in accordance with aspects of the present disclosure. The multi-RTT positioning technique makes use of the UE Rx-Tx measurements and DL PRS RSRP of downlink signals received from multiple TRPs, as measured by the UE and the measured gNB Rx-Tx measurements and uplink sounding reference signal (SRS) RSRP (UL SRS-RSRP) at multiple TRPs of uplink signals transmitted from UE. The UE measures the UE Rx-Tx measurements (and optionally DL PRS RSRP of the received signals) using assistance data received from the positioning server (also referred to herein as the location server), and the TRPs the gNB Rx-Tx measurements (and optionally UL SRS-RSRP of the received signals) using assistance data received from the positioning server. The measurements are used to determine the RTT at the positioning server, which are used to estimate the location of the UE. In Release 16 the multi-RTT is only supported for UE-assisted and NG-RAN assisted positioning techniques as noted in Table 1.

FIG. 5 illustrates an example of a system 500 for existing relative range estimation as related to combined one-to-many and many-to-one sidelink positioning in accordance with aspects of the present disclosure. The system 500 illustrates the relative range estimation using the existing single gNB RTT positioning framework. The location server (LMF) can configure measurements to the different UEs, and then the target UEs can report their measurements in a transparent way to the location server. The location server can compute the absolute location, but in order to get the relative distance between two of the UEs, it would need prior information, such as the locations of the target UEs. This approach is high in latency and is not an efficient method in terms of procedures and signaling overhead.

For the NR enhanced cell ID (E-CID) positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR enhanced cell-ID (NR E-CID) positioning refers to techniques which use additional UE measurements and/or NR radio resources and other measurements to improve the UE location estimate using NR signals. Although enhanced cell-ID (E-CID) positioning may utilize some of the same measurements as the measurement control system in the RRC protocol, the UE may not make additional measurements for the sole purpose of positioning (i.e., the positioning procedures do not supply a measurement configuration or measurement control message, and the UE reports the measurements that it has available rather than being required to take additional measurement actions).

The uplink time difference of arrival (UL-TDOA) positioning technique makes use of the UL-RTOA (and optionally UL SRS-RSRP) at multiple reception points (RPs) of uplink signals transmitted from UE. The RPs measure the UL-RTOA (and optionally UL SRS-RSRP) of the received signals using assistance data received from the positioning server, and the resulting measurements are used along with other configuration information to estimate the location of the UE.

The uplink angle of arrival (UL-AoA) positioning technique makes use of the measured azimuth and the zenith of arrival at multiple RPs of uplink signals transmitted from UE. The RPs measure azimuth-AoA (A-AoA) and zenith-AoA (Z-AoA) of the received signals using assistance data received from the positioning server (also referred to herein as the location server), and the resulting measurements are used along with other configuration information to estimate the location of the UE.

Various RAT-independent positioning techniques may also be used, such as network-assisted GNSS techniques, barometric pressure sensor positioning, WLAN positioning, Bluetooth positioning, TBS positioning, and motion sensor positioning.

Network-assisted GNSS techniques make use of UEs that are equipped with radio receivers capable of receiving GNSS signals. In 3GPP specifications the term GNSS encompasses both global and regional/augmentation navigation satellite systems. Examples of global navigation satellite systems include GPS, Modernized GPS, Galileo, GLONASS, and BeiDou Navigation Satellite System (BDS). Regional navigation satellite systems include Quasi Zenith Satellite System (QZSS) while the many augmentation systems are classified under the generic term of Space Based Augmentation Systems (SBAS) and provide regional augmentation services. Network-assisted GNSS techniques may use different GNSSs (e.g., GPS, Galileo, etc.) separately or in combination to determine the location of a UE.

Barometric pressure sensor positioning techniques make use of barometric sensors to determine the vertical component of the position of the UE. The UE measures barometric pressure, optionally aided by assistance data, to calculate the vertical component of its location or to send measurements to the positioning server for position calculation. This technique should be combined with other positioning methods to determine the 3D position of the UE.

WLAN positioning techniques makes use of the WLAN measurements (AP identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Additionally or alternatively, the UE makes use of WLAN measurements and optionally WLAN AP assistance data provided by the positioning server to determine its location.

Bluetooth positioning techniques makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g., WLAN) to improve positioning accuracy of the UE.

TBS positioning techniques make use of a TBS, which includes a network of ground-based transmitters, broadcasting signals only for positioning purposes. Examples of types of TBS positioning signals are MBS (Metropolitan Beacon System) signals and Positioning Reference Signals (PRS). The UE measures received TBS signals, optionally aided by assistance data, to calculate its location or to send measurements to the positioning server for position calculation.

Motion sensor positioning techniques makes use of different sensors such as accelerometers, gyros, magnetometers, and so forth to calculate the displacement of UE. The UE estimates a relative displacement based upon a reference position and/or reference time. The UE sends a report comprising the determined relative displacement which can be used to determine the absolute position. This method can be used with other positioning methods for hybrid positioning.

Different DL measurements used for RAT-dependent positioning techniques include including DL PRS-RSRP, DL RSTD and UE Rx-Tx Time Difference. The following measurement configurations may be used: 4 Pair of DL RSTD measurements can be performed per pair of cells, and each measurement is performed between a different pair of DL PRS Resources/Resource Sets with a single reference timing; 8 DL PRS RSRP measurements can be performed on different DL PRS resources from the same cell.

DL PRS reference signal received power (DL PRS-RSRP) is defined as the linear average over the power contributions (in [W]) of the resource elements that carry DL PRS reference signals configured for RSRP measurements within the considered measurement frequency bandwidth. For frequency range 1, the reference point for the DL PRS-RSRP is the antenna connector of the UE. For frequency range 2, DL PRS-RSRP is measured based on the combined signal from antenna elements corresponding to a given receiver branch. For frequency range 1 and 2, if receiver diversity is in use by the UE, the reported DL PRS-RSRP value is not lower than the corresponding DL PRS-RSRP of any of the individual receiver branches. DL PRS-RSRP is applicable for RRC_CONNECTED intra-frequency and RRC_CONNECTED inter-frequency.

DL reference signal time difference (DL RSTD) is the DL relative timing difference between the positioning node j and the reference positioning node i, defined as T_{SubframeRxj}−T_{SubframeRxi}, where T_{SubframeRxj} is the time when the UE receives the start of one subframe from positioning node j, and T_{SubframeRxi} is the time when the UE receives the corresponding start of one subframe from positioning node i that is closest in time to the subframe received from positioning node j. Multiple DL PRS resources can be used to determine the start of one subframe from a positioning node. For frequency range 1, the reference point for the DL RSTD is the antenna connector of the UE. For frequency range 2, the reference point for the DL RSTD is the antenna of the UE. DL RSTD is applicable for RRC_CONNECTED intra-frequency and RRC_CONNECTED inter-frequency.

The UE Rx-Tx time difference is defined as T_{UE-RX}-T_{UE-TX}, where T_{UE-RX} is the UE received timing of downlink subframe #i from a positioning node, defined by the first detected path in time, and T_{UE-TX} is the UE transmit timing of uplink subframe #j that is closest in time to the subframe #i received from the positioning node. Multiple DL PRS resources can be used to determine the start of one subframe of the first arrival path of the positioning node. For frequency range 1, the reference point for T_{UE-RX} measurement shall be the Rx antenna connector of the UE and the reference point for T_{UE-TX} measurement shall be the Tx antenna connector of the UE. For frequency range 2, the reference point for T_{UE-RX} measurement shall be the Rx antenna of the UE and the reference point for T_{UE-TX} measurement shall be the Tx antenna of the UE. The UE Rx-Tx time difference is applicable for RRC_CONNECTED intra-frequency and RRC_CONNECTED inter-frequency.

The DL PRS reference signal received path power (DL PRS-RSRPP) is defined as the power of the linear average of the channel response at the i-th path delay of the resource elements that carry DL PRS signal configured for the measurement, where DL PRS-RSRPP for the 1st path delay is the power contribution corresponding to the first detected path in time. For frequency range 1, the reference point for the DL PRS-RSRPP is the antenna connector of the UE. For frequency range 2, DL PRS-RSRPP is measured based on the combined signal from antenna elements corresponding to a given receiver branch. DL PRS-RSRPP is applicable for RRC_CONNECTED and RRC_INACTIVE.

In one or more implementations, with regards to the positioning methods supported using SL measurements, the following methods are considered: RTT-type solutions using SL, including both single-sided (also known as one-way) and double-sided (also known as two-way) RTT; SL-AoA, including both Azimuth of arrival and zenith of arrival; SL-TDoA; SL-AoD, corresponding to a method where RSRP and/or RSRPP measurements similar to the DL-AoD method in Uu, and including both Azimuth of departure (AoD) and zenith of departure (ZoD).

In one or more implementations, the following aspects are considered: definition(s) of the corresponding SL measurements for each method; which method is applicable to absolute or relative positioning or ranging, including whether such categorization is to be used; for angle-based methods, antenna configuration consideration(s) using practical UE capabilities; per-panel location, if UE uses multiple panels; UE's mobility, especially for V2X scenarios; impact of synchronization error(s) between UEs; existing SL measurements (e.g., RSSI, RSRP), and UE ID information etc., may be used. The above categorization does not necessarily mean that there will be separate SL positioning methods specified, or whether there will be a unified SL Positioning method. When carrier phase positioning and the evaluations of sidelink positioning have progressed, whether carrier phase for sidelink can be considered in further work can be reviewed. The role of SL nodes and their interaction/coordination participating in each method can be described.

In one or more implementations, with regards to the configuration, activation, deactivation, or triggering of SL-PRS, the following options are considered. One option is high-layer-only signaling involvement in the SL-PRS configuration. No Lower layer involvement, e.g., SL-MAC-CE or SCI or DCI, for the activation or the triggering of a SL-PRS. This option may correspond to an SL-PRS configuration that is a single-shot or multiple shots, or a high-layer configuration that may be received from an LMF, a gNB, or a UE.

Another option is high-layer and lower-layer signaling involvement in the SL-PRS configuration. Lower-layer may correspond to SL-MAC-CE, or SCI, or DCI. For example, high layer signaling can may be used for SL-PRS configuration and lower layer signaling can may be used for initiating SL positioning and/or configuration, triggering, activating, deactivating, or indicating and potential resource indication/reservation transmission of SL-PRS.

Another option is only lower-layer signaling involvement in the SL-PRS configuration. Lower-layer may correspond to SL-MAC-CE, or SCI, or DCI.

Aspects in related to flexibility, overhead, latency, and reliability may also be considered.

In one or more implementations, with regards to the Sidelink Positioning measurement report, the contents of the measurement report (e.g., time stamp(s), quality metric(s), ID(s), angular/timing/power measurements, etc.) are considered. Additionally or alternatively, the time domain behavior of the measurement report (e.g., one-shot, triggered, aperiodic, semi-persistent, periodic) is considered. Additionally or alternatively, whether the Sidelink Positioning measurement can be a high-layer report and/or a lower layer report is considered.

In one or more implementations, with regards to the SL Positioning resource allocation, the following options for SL Positioning resource (pre-) configuration. One option is dedicated resource pool for SL-PRS. This includes considering one or more of the following aspects: which slots can be used, SL frame structure, SL positioning slot structure, multiplexing of SL-PRS with control information (if included in the same slot); positioning measurement report; whether a dedicated frequency allocation (e.g., layer/BWP) is used for SL PRS; resource allocation procedure(s) of SL-PRS; control information (e.g., configuration, activation, deactivation, or triggering of SL-PRS) for the purpose of SL positioning operation.

Another option is shared resource pool with sidelink communication. This includes considering one or more of: co-existence between SL communication and SL positioning, backward compatibility; multiplexing considerations of SL-PRS with other PHY channels (PSCCH, PSSCH, PSFCH) and any modifications in the SL-slot structure.

In one or more implementations, regarding SL-PRS resource allocation, introducing both Scheme 1 and Scheme 2 for supporting SL positioning/ranging is considered. Scheme 1 refers to network-centric operation SL-PRS resource allocation (e.g., similar to a legacy Mode 1 solution). The network (e.g., gNB, LMF, gNB & LMF) allocates resources for SL-PRS. Scheme 2 refers to UE autonomous SL-PRS resource allocation (e.g., similar to legacy Mode 2 solution). At least one of the UE(s) participating in the sidelink positioning operation allocates resources for SL-PRS. Regarding Scheme 2 SL-PRS resource allocation, one or more of resource selection mechanism for SL-PRS, inter-UE coordination, and aspects for congestion control mechanisms for SL-PRS can be considered.

In one or more implementations, with regards to the SL Positioning resource allocation, one of the following alternatives for supporting SL positioning/ranging is considered. One alternative is only dedicated resource pool(s) can be (pre-) configured for SL-PRS. Another alternative is either dedicated resource pool(s) and/or a shared resource pool(s) with sidelink communication can be (pre-) configured for SL-PRS. Whether other signals/channels can be present in the dedicated resource pool can also be considered.

In one or more implementations, an initiator device initiates a SL positioning/ranging session, and may be a network entity, (e.g., gNB, LMF) or UE/roadside unit (RSU).

In one or more implementations, a responder device responds to a SL positioning/ranging session from an initiator device, and may be a network entity, (e.g., gNB, LMF) or UE/roadside unit (RSU).

In one or more implementations, a target-UE (or target UE) may be referred to as a UE of interest whose position (absolute or relative) is to be obtained by the network or by the UE itself (e.g., using SL, e.g., PC5 interface).

In one or more implementations, sidelink positioning refers to positioning a UE using reference signals transmitted over SL, e.g., PC5 interface, to obtain absolute position, relative position, or ranging information.

In one or more implementations, ranging refers to a determination of the distance and/or the direction between a UE and another entity, e.g., an anchor UE.

In one or more implementations, an anchor UE refers to a UE supporting positioning of a target UE, e.g., by transmitting and/or receiving reference signals for positioning, providing positioning-related information, etc., over the SL interface. May also be referred to as a reference UE or SL reference UE.

In one or more implementations, an assistant UE refers to a UE supporting ranging/sidelink between a SL reference UE and target UE over SL (e.g., PC5 interface), when the direct ranging/sidelink positioning between the SL reference UE/anchor UE and the target UE cannot be supported. The measurement/results of the ranging/sidelink positioning between the assistance UE and the SL reference UE and that between the assistance UE and the target UE are determined and used to derive the ranging/sidelink positioning results between target UE and SL reference UE.

In one or more implementations, a SL positioning server UE refers to a UE offering location calculation, for SL positioning and ranging based service. It interacts with other UEs over SL (e.g., PC5 interface) as necessary in order to calculate the location of the target UE. The target UE or SL reference UE can act as a SL positioning server UE if location calculation is supported.

In one or more implementations, a SL positioning client UE refers to a third-party UE, other than SL reference UE and target UE, which initiates ranging/sidelink positioning service request on behalf of the application residing on it. The SL positioning client UE does not have to support ranging/sidelink positioning capability, but a communication between the SL positioning client UE and SL reference UE/target UE is established, e.g., via PC5 or 5GC, for the transmission of the service request and the result.

In one or more implementations, a SL positioning node may refer to a network entity and/or device/UE participating in a SL positioning session, e.g., LMF (location server), gNB, UE, RSU, anchor UE, initiator and/or responder UE.

In one or more implementations, a configuration entity refers to a node network node or device/UE capable of configuring time-frequency resources and related SL positioning configurations. A SL positioning server UE may serve as a configuration entity.

In one or more implementations, sidelink positioning reference signal (SL PRS) refers to a reference signal transmitted over SL for positioning purposes.

In one or more implementations, SL PRS (pre-) configuration refers to (pre-) configured parameters of SL PRS such as time-frequency resources (other parameters are not precluded) including its bandwidth and periodicity.

Various solutions for enabling one-to-many SL Positioning in order to support SL-TDoA are discussed herein. In one or more implementations, use of many-to-one and one-to-many SL-TDoA are combined within one procedure in an efficient manner. Additionally or alternatively, the reference anchor node selection and configuration is enhanced and the synchronization information is provided between the reference anchor node and other anchor nodes to enable accurate SL-RSTD measurements. Additionally or alternatively, the anchor nodes receive assistance information in terms of an expected search window and associated uncertainty to perform the SL-RTOA measurements. The various solutions discussed herein may be implemented in combination with each other to support NR RAT-dependent positioning methods over the SL (e.g., PC5) interface.

In one or more implementations, a positioning-related reference signal may be referred to as a reference signal used for positioning procedures/purposes in order to estimate a target-UE's location, e.g., PRS, or based on existing reference signals such as CSI-RS or SRS. A target-UE may be referred to as the device/entity to be localized/positioned. In various implementations, the term ‘PRS’ may refer to any signal such as a reference signal, which may or may not be used primarily for positioning.

In one or more implementations, references to position/location information may refer to an absolute position, relative position with respect to another node/entity, ranging in terms of distance, ranging in terms of direction or a combination thereof.

In one or more implementations, a trigger to perform sidelink positioning is a configuration message that may include the associated request and procedures to perform: one-to-many sidelink positioning, many-to-one sidelink positioning, or both one-to-many and many-to-one sidelink positioning.

In one or more implementations, SL-TDoA may comprise of different SL-TDoA variants including 1) one-to-many, 2) many-to-one, and 3) both one-to-many and many-to-one. The Target-UE may receive a trigger from the high-layers to perform a plurality of SL-TDoA variants to determine location information comprising absolute position(s), relative position(s) or ranging comprising of the ranging distance and/or ranging direction between the initiator UE/device and one or more responder UEs/devices.

The trigger may also comprise which of the SL-TDoA variants to perform including many-to-one and/or one-to-many SL-TDoA or both. An example of this trigger indication is a bit indication where “001” triggers one-to-many SL-TDoA, “011” triggers many-to-one SL-TDoA and “111” triggers both one-to-many and many-to-one SL-TDoA. Additionally or alternatively, the trigger may be signaled as a choice or sequence according to ASNI code. Additionally or alternatively, the lower layers (e.g., physical layer including SCI, PSCCH, PSSCH) may trigger the higher-layer as to which SL-TDoA variant is possible depending on the available resources selected using Mode 1 and/or Mode 2 resource allocation schemes, where Mode 1 is a centralized resource allocation scheme for SL-PRS and sidelink positioning messages and Mode 2 is a decentralized scheme based on sensing, reservation and selection of resources.

The higher-layer may comprise of the functionality including the PC5-S or PC5 RRC layer or a functionality above the PC5-S/PC5 RRC layer, e.g., sidelink positioning protocol layer (SLPP or RSPP), V2X/ProSe layer, application layer with the associated sidelink positioning group information for performing one-to-many SL-TDoA including sidelink Group ID, sidelink group members, group size, group capability information. Additionally or alternatively, the sidelink positioning group may be established on the AS layer/RAN/lower layers, based on the resource availability, number of available sidelink positioning UEs involved in a SL-TDoA positioning session, e.g., anchor/reference UEs.

The triggering message may include any one or more a variety of different general sidelink positioning parameters.

In one or more implementations, the triggering message includes a number of identified/discovered anchor UEs.

Additionally or alternatively, the triggering message includes an indication of a type of sidelink positioning method, e.g., SL-TDoA variant to be used, e.g., One-to-Many SL-TDoA, Many-to-One SL-TDoA, Both One-to-many SL-TDoA and many-to-one SL-TDoA or SL-RTT variant, e.g., single-sided or double-sided RTT or the like.

Additionally or alternatively, the triggering message includes an indication on the transmission order of SL-PRS, e.g., starting with the initiator/Tx UE or starting with the Responder/Rx UE(s).

Additionally or alternatively, the triggering message includes UE IDs of the anchor UE/devices and of the target-UE, e.g., source-ID, destination-IDs, sidelink positioning specific source/destination IDs.

Additionally or alternatively, the triggering message includes a UE ID or device ID of the reference node (if configured). Such a reference node may be selected by a discovery mechanism or via a configuration from the higher layer.

Additionally or alternatively, the triggering message includes a cast-type indicator for SL-PRS transmission, e.g., unicast, groupcast, broadcast or combination thereof.

Additionally or alternatively, the triggering message includes cast-type indicator for one-to-many or many-to-one sidelink assistance data, sidelink positioning measurement report, error, abort messages, e.g., unicast, groupcast, broadcast or combination thereof.

Additionally or alternatively, the triggering message includes an indication of the configured reference anchor node.

Additionally or alternatively, the triggering message includes an indication whether this is a network-assisted, UE-only operation or combination of both. Network assisted operation refers to operation of ranging/sidelink positioning with the involvement of 5GC NFs (network functions) for the service request handling and result calculation. UE-only operation refers to operation of ranging/sidelink positioning in which the service request handling and result calculation are performed by UE. Combination refers to where the service request handling is done at the network and positioning result calculation at the UE or service request handling is done at the UE and the positioning result calculation at the network-side.

Additionally or alternatively, the triggering message includes an indication whether the joint Uu+SL positioning is enabled. Joint Uu+SL positioning implies that the anchor UEs/device receive assistance from fixed gNBs/TRPs for the purposes of the absolute position estimation of the target-UE and may involve the reception of DL-PRS and transmission of SRS for positioning. This may include an indication which Uu positioning method is used in conjunction with SL Positioning to perform joint Uu+SL positioning.

Additionally or alternatively, the triggering message includes a desired sidelink positioning quality of service (QoS) in terms of absolute/relative horizontal and vertical positioning accuracy. In one or more implementations, the positioning delay or latency may also be signaled to the anchor and target UEs.

Additionally or alternatively, the triggering message includes a trigger to select the same synchronization reference source (if not already configured). This may be based on a priority indication for selecting the same synchronization reference source. The synchronization reference source may comprise of GNSS, gNB and other UEs. This may include a procedure to trigger anchor UEs synchronization to perform any one of the variants of SL-TDoA.

The triggering message discussed above may be transferred using sidelink control-plane signaling encapsulated as a sidelink positioning protocol message (SLPP/RSPP) and transmitted to the lower layers via PC5-S/PC5 RRC. Additionally or alternatively, the triggering message may be transmitted as sidelink user-plane PDU(s) with an associated sidelink QoS (PQI parameters, which can be mapped to the sidelink positioning QoS).

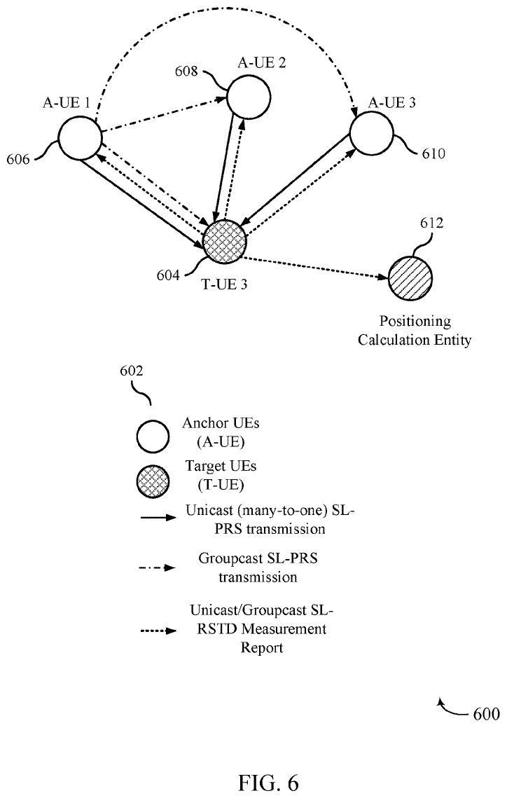

FIG. 6 illustrates an example of a system 600 using many-to-one SL-TDoA as related to combined one-to-many and many-to-one sidelink positioning in accordance with aspects of the present disclosure. A key 602 is included for convenience. A target UE 604 is illustrated along with multiple anchor UEs 606, 608, and 610. The anchor UEs 606, 608, and 610 transmit the SL-PRS in a many-to-one fashion or manner (unicast) towards the target UE 604 for the measurement of the SL-RSTD measurement. An anchor UE 606 also transmits an SL-PRS (groupcast) to the target UE 604, the anchor UE 608, and the anchor UE 610. The target UE 604 responds with a unicast or groupcast transmission to the anchor UEs 606, 608, and 610 as well as a positioning calculation entity 612, the transmission including a sidelink reference signal time difference (SL-RSTD) measurement report. The positioning calculation entity 612 can be any entity or node, such as a location server which may also be referred to as a location management function, a network entity 102 (e.g., gNB), a sidelink positioning server UE, a sidelink positioning client UE, and so forth.

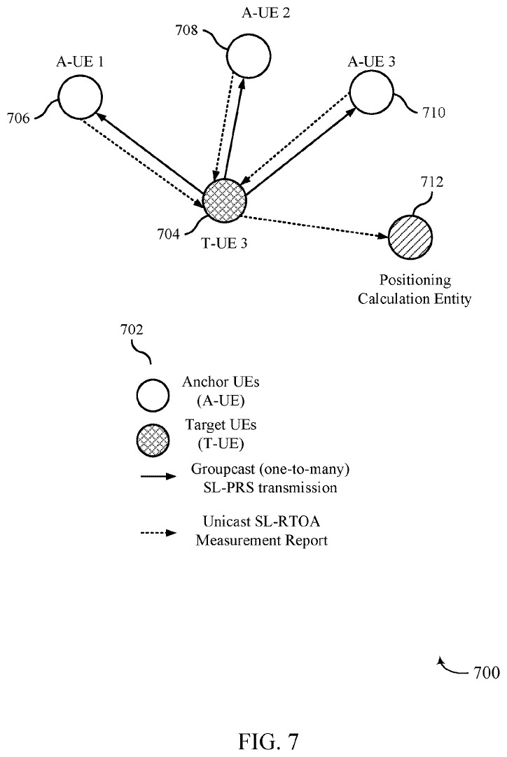

FIG. 7 illustrates an example of a system 700 using one-to-many SL-TDoA as related to combined one-to-many and many-to-one sidelink positioning in accordance with aspects of the present disclosure. A key 702 is included for convenience. A target UE 704 is illustrated along with multiple anchor UEs 706, 708, and 710. The target UE 704 transmits the SL-PRS in a one-to-many fashion (groupcast) to the anchor UEs 706, 708, and 710 for the measurement of the SL-RSTD measurement. The anchor UEs 706, 708, and 710 each respond with a unicast transmission to the target UE 704, the transmission including a sidelink relative time of arrival (SL-RTOA) measurement report. The target UE 704 may make a unicast transmission, to a positioning calculation entity 712, that includes the SL-RTOA measurement report. The positioning calculation entity 712 can be any entity or node, such as a location server which may also be referred to as a location management function, a network entity 102 (e.g., gNB), a sidelink positioning server UE, a sidelink positioning client UE, and so forth.

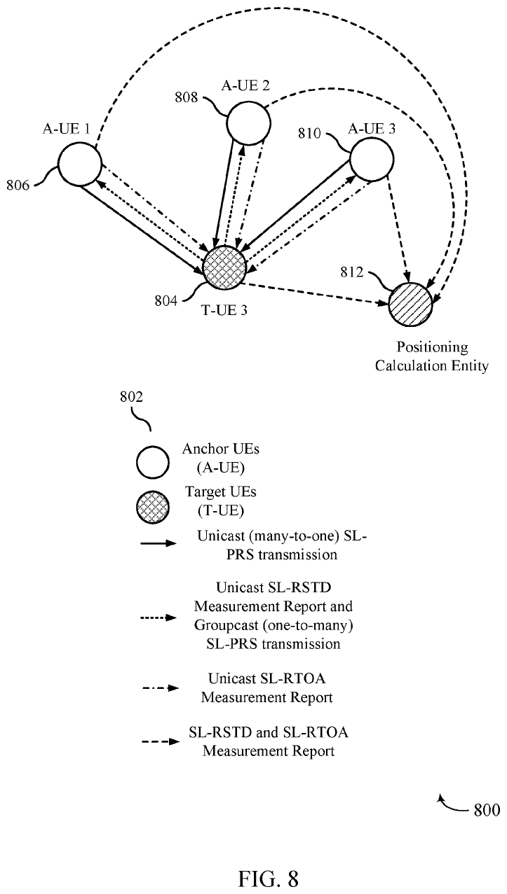

FIG. 8 illustrates an example of a system 800 using combined one-to-many and many-to-one SL-TDoA as related to combined one-to-many and many-to-one sidelink positioning in accordance with aspects of the present disclosure. A key 802 is included for convenience. A target UE 804 is illustrated along with multiple anchor UEs 806, 808, and 810 as well as a positioning calculation entity 812. The positioning calculation entity 812 can be any entity or node, such as a location server which may also be referred to as a location management function, a network entity 102 (e.g., gNB), a sidelink positioning server UE, a sidelink positioning client UE, and so forth.

In one or more implementations, the UEs 804, 806, 808, and 810 receive a request to perform a combined SL-TDoA procedure involving both one-to-many SL-TDoA and many-to-one SL-TDoA as follows. It is assumed that the anchor UEs 806, 808, and 810 and target UE 804 have received the necessary resource allocations either via mode 1 or mode 2 resource allocation procedures to transmit SL-PRS, e.g., via receiving the SLPP/RSPP SL Provide Assistance Data message.

The anchor UEs 806, 808, and 810 transmit the SL-PRS in a many-to-one fashion (unicast or groupcast) towards the target-UE for the measurement of the SL-RSTD measurement, where SL reference signal time difference (SL-RSTD) is defined as the sidelink relative timing difference between the transmission point (TP)/anchor node/UE j and the reference TP/anchor node/UE i, defined as T_{SubframeRx,j}−T_{SubframeRx,i}, where: T_{SubframeRx,j} is the time when the UE receives the start of one subframe from TP/anchor node/UE j and T_{SubframeRx,i} is the time when the UE receives the corresponding start of one subframe from the TP/anchor node/UE i that is closest in time to the subframe received from TP/anchor node/UE j. One or more SL-PRS resources can be used to determine the start of one subframe from a TP/anchor node/UE. The target UE measures the SL-RSTD with respect to the reference anchor node/device in order to derive the RSTD measurement. This SL-PRS transmission may include an additional indication as to whether the SL-PRS in a one-to-many fashion is to be transmitted by the target UE, which may be signaled in either the 1^{st} or 2^{nd} stage SCI and whether the SL-PRS to be transmitted by the target UE is to be transmitted using the same or different sidelink positioning resource pool.

The target UE 804 performs the SL-RSTD measurement(s) corresponding to the number anchor UEs/nodes. In one or more implementations, the target UE stores the SL-RSTD measurements to be transmitted in a combined sidelink positioning measurement report to the positioning calculation entity 812 described below. Additionally or alternatively, the target UE 804 transmits the SL-RSTD measurement report (e.g., an information element (IE) within a SLPP/RSPP SL Provide Location Information message) to a positioning calculation entity before or after transmitting the SL-PRS to the anchor UEs/nodes/devices.

The target UE 804 transmits the SL-PRS in a one-to-many (groupcast) fashion towards the anchor UEs 806, 808, and 810, for the measurement of the SL-RTOA measurement, where the sidelink relative time of arrival (T_{SL-RTOA}) is the start point/beginning of the SL subframe i containing SL-PRS resources received at each anchor UE/node/device, relative to the SL-RTOA reference time. The SL-RTOA reference time is defined as the T₀+t_{SL-PRS}, where T₀ is the nominal start time of the sidelink system frame number (SFN) 0 or direct frame number (DFN) 0. This T₀ may be signaled to the anchor UEs 806, 808, and 810 beforehand by a network entity or by other UE participating in a sidelink positioning, e.g., LMF, gNB, other anchor UEs, sidelink positioning server UEs, SL-PRS configuration UE, target UE or the like. t_{SL-PRS} may be computed using the following computation: ((10n_{SL-F}+N_{SL-SF})×10⁻³, where n_{SL-F} and n_{SL-SF} are the SL system frame number or in other implementations the DFN and subframe number of the SL-PRS resources, respectively.

The anchor UEs/nodes 806, 808, and 810 may then report the SL-RTOA to the target-UE 804, e.g., via within a SLPP/RSPP SL Provide Location Information message. Additionally or alternatively, the anchor UEs/nodes 806, 808, and 810 may report the SL-RTOA to a separate positioning calculation entity 812, e.g., other anchor UEs, sidelink positioning server UEs, SL-PRS configuration UE, or the like.

The target UE 804 computes its position based on the combined SL-RSTD and SL-RTOA measurement for an enhanced location estimate. The calculated position may comprise of an absolute position, relative position or ranging distance with respect to one or more of the anchor UEs/nodes 806, 808, or 810. Additionally or alternatively, a separate positioning calculation entity 812, e.g., other anchor UEs, sidelink positioning server UEs, SL-PRS configuration UE, or the like may compute the position based on the received combined SL-RSTD and SL-RTOA measurements as described. Additionally or alternatively, the combined SL-TDoA may be used in conjunction with other sidelink positioning techniques such as SL-RTT (single-sided and/or double-sided), sidelink angle-of-arrival (SL-AoA), sidelink angle-of-departure (SL-AoD), SL-ECID, and so forth.

In one or more implementations of the combined SL-TDoA technique, the procedure may start with the target UE 804 transmitting the one-to-many SL-PRS for the measurement of SL-RTOA followed by the reception of the SL-PRS transmitted by the anchor UEs 806, 808, and 810 for the measurement of the SL-RSTD measurement.

Additionally or alternatively, the positioning measurement reports may be groupcasted from either the target UE 804 or an anchor UE 806, 808, or 810 to other anchor UEs 806, 808, or 810 for positioning calculation. Additionally or alternatively, the SL-PRS may be transmitted in a unicast fashion to measure the SL-RSTD and/or SL-RTOA measurement.

In one or more implementations, SL-RTT may comprise of different SL-RTT options/variants including: 1) unicast single-sided and/or double-sided SL-RTT; 2) one-to-many and many-to-one single-sided and/or double-sided SL-RTT; 3) initial unicast transmission of SL-PRS/SL RS/SL Positioning message by the Tx/initiator UE for SL single-sided and/or double-sided SL-RTT and many-to-one or one-to-many transmission of the reply SL-PRS/SL RS/SL Positioning message by the Rx/Responder UE; and 4) many-to-one or one-to-many transmission of the SL-PRS/SL RS/SL Positioning message by the Tx/Transmitter UE and unicast transmission of the reply SL-PRS/SL RS/SL Positioning message by the Rx/Responder UE.

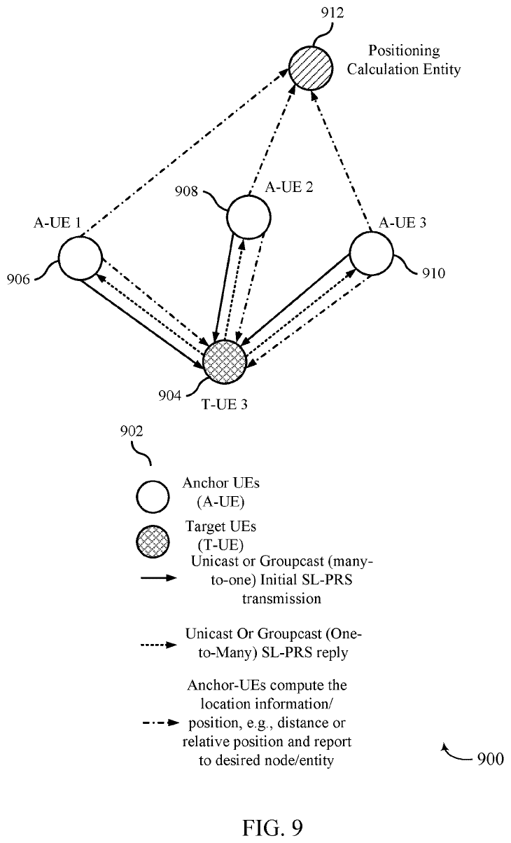

FIG. 9 illustrates an example of a system 900 using SL-RTT as related to combined one-to-many and many-to-one sidelink positioning in accordance with aspects of the present disclosure. Multiple SL-RTT options are illustrated in the system 900. A key 902 is included for convenience. A target UE 904 is illustrated along with multiple anchor UEs 906, 908, and 910 as well as a positioning calculation entity 912. The positioning calculation entity 912 can be any entity or node, such as a location server which may also be referred to as a location management function, a network entity 102 (e.g., gNB), a sidelink positioning server UE, a sidelink positioning client UE, and so forth. The system 900 illustrates an example of unicast, many-to-one and one-to-many SL-PRS/SL RS/SL positioning message.

Multiple SL-RTT options for single-sided RTT are illustrated in the system 900. This may also extend to double-sided SL-RTT through the transmission of an additional SL-PRS/SL RS/SL Positioning message after the SL-PRS reply signal.

In one or more implementations, the participating UEs 904, 906, 908, and 910 receive a request to perform a combined SL-RTT procedure involving unicast, one-to-many or many-to-one SL-PRS transmissions as part of a SL-RTT positioning technique as follows. It is assumed that the anchor UEs 906, 908, and 910 and target UE 904 have received the necessary resource allocations either via mode 1 or mode 2 resource allocation procedures to transmit SL-PRS, e.g., via receiving a SL positioning resource pool, dedicated or shared in a SLPP/RSPP SL Provide Assistance Data message or via SIB/UE-specific RRC signaling or via sensing, reservation and selection of SL-PRS resources.

The anchor UEs 906, 908, and 910 transmit the SL-PRS in a many-to-one fashion (groupcast) towards the target-UE 904 for the measurement of the sidelink UE Rx-Tx time difference measurement, where sidelink reference signal time difference (sidelink UE Rx-Tx time difference measurement) is defined as the difference between the reception time of a SL-PRS/SL RS/SL positioning message and subsequent transmission time of another SL-PRS/SL RS/SL positioning message, T_{UE-RX}-T_{UE-TX}, where T_{UE-RX} is the UE received timing of the sidelink subframe #i from an anchor UE/node/target UE, defined by the first detected path in time and T_{UE-TX} is defined as the UE transmit timing of the sidelink subframe #j that is closest in time to the subframe #i received from the same anchor node/UE/target-UE.

This SL-PRS transmission may include an additional indication as to whether the SL-PRS in a one-to-many fashion is to be transmitted by the target UE 904, which may be signaled in either the 1st or 2nd stage SCI and whether the SL-PRS to be transmitted by the target UE 904 is to be transmitted using the same/different SL positioning resource pool.

In the case of double-sided RTT, one UE/device within a SL-RTT pair may calculate the initial round sidelink UE Rx-Tx time difference measurement (1), while the other peer UE/device may calculate the 2nd round sidelink UE Rx-Tx time difference measurement (2), where (1) and (2) may be combined to obtained an enhanced positioning estimate, e.g., absolute position, relative position, ranging distance. Additionally or alternatively, this combined sidelink UE Rx-Tx time difference measurement (1)+(2) may be signaled to the positioning calculation entity 912 for position computation, e.g., using the SL Provide Location Information SLPP/RSPP message.

In one or more implementations of double-sided RTT, a new measurement may be defined known as T_{UE-RX0}−T_{UE-TX0}−T_{UE-RX1}−T_{UE-TX1}, where T_{UE-RX1} is the 1st received timing of the sidelink subframe #i from a 1st anchor UE/node/target UE, defined by the first detected path in time, T_{UE-TX1} is defined as the UE transmit timing of the sidelink subframe #j that is closest in time to the subframe #i received from the same 1st anchor node/UE/target UE, T_{UE-RX2} is the UE received timing of the sidelink subframe #i from a 2nd anchor UE/node/target UE, defined by the first detected path in time, T_{UE-TX2} is defined as the UE transmit timing of the sidelink subframe #j that is closest in time to the subframe #i received from the same 2nd anchor node/UE/target UE.

The target UE 904 may transmit the reply SL-PRS/SL RS/SL positioning message in a uncast or one-to-many fashion depending on the received (pre-) configuration, e.g., received from higher-layers, from another entity node via reconfiguration message, assistance data signaling, e.g., Provide Assistance Data SLPP/RSPP message, or other lower layer signaling such as SCI, SL MAC CE.

N different SL UE Rx-Tx time difference measurements may be collected by the N anchor devices and signaled to the target UE 904 or other positioning calculation entity 912 for position calculation. In another aspect, each of the anchor UEs 906, 908, and 910 may collect M SL UE Rx-Tx time difference measurements corresponding with either the first path or additional paths, which are measured based on a received configuration. A positioning calculation UE can therefore collect N×M total SL UE Rx-Tx time difference measurements. For measurement tracking each of the measurements from the anchor devices or in other implementations, a target-UE, 906, 908, and 910 may be associated with a measurement ID, e.g., measurement object ID and/or UE-ID indicating which UE-node performed the respective measurement and this may encompass SL Positioning measurements such as SL-RSTD, SL-RTOA, SL UE Rx-Tx time difference, SL-AoA, SL-RSRP, SL-RSRPP, SL-AoD. Different measurements may be grouped according to a single ID based on a variety factors including the UE reporting measurements, e.g., initiating UE or responding UE, type of positioning measurements or combinations thereof.

The measurements may be reported to another positioning calculation entity 912, which may be different to nodes/entities involved in the SL-PRS transmission.

The target UE 904 may receive a trigger from the high-layers to perform a plurality of SL-RTT variants, e.g., based on many-to-one or one-to-many transmissions, single-sided RTT or double-sided RTT to determine location information comprising of absolute position(s), relative position(s) or ranging comprising of the ranging distance and/or ranging direction between the initiator UE/device and one or more responder UEs/devices. Additionally or alternatively, the triggering message may originate from the communication layer that is responsible for the SL positioning method selection and anchor/reference anchor selection, e.g., SLPP/RSPP layer or other cases a separate UE/device with aforementioned functionality.

In one or more implementations, the trigger may also comprise which of the SL-RTT variants as listed above. An example of this trigger indication includes bit indication where “0001” triggers Option 1), “0011” triggers Option 2, “0111” triggers Option 3, and “1111” triggers Option 4. In alternative implementation the trigger may be signaled as a choice or sequence according to ASNI code. In another alternative implementation, the lower layers (e.g., physical layer including SCI, PSCCH, PSSCH) may trigger the higher-layer as to which SL-RTT variant is possible depending on the available resources selected using Mode 1 and/or Mode 2 resource allocation schemes, where Mode 1 is a centralized resource allocation scheme for SL-PRS and sidelink positioning messages and Mode 2 is a decentralized scheme based on sensing, reservation and selection of resources.

The higher-layer may comprise of the functionality including the PC5-S or PC5 RRC layer or a functionality above the PC5-S/PC5 RRC layer e.g., a sidelink positioning protocol layer (SLPP or RSPP), a V2X/ProSe layer, an application layer with the associated SL positioning group information for performing one-to-many and many-to-one SL-RTT including SL Group ID, sidelink group members, a group size, a group capability information. Additionally or alternatively, the sidelink positioning group may be established on the AS layer/RAN/lower layers, based on the resource availability, number of available sidelink positioning UEs involved in a SL-RTT positioning session, e.g., anchor or reference UEs.

Additionally or alternatively, other sidelink positioning techniques such as SL-AoA may use unicast, one-to-many, or many-to-one SL-PRS transmissions for determining the position information. In this case, the SL-AoA may be defined as the estimated azimuth angle and vertical angle of a UE with respect to a reference direction, wherein the reference direction is defined in the global coordinate system (GCS), wherein estimated azimuth angle is measured relative to geographical North and is positive in a counter-clockwise direction and estimated vertical angle is measured relative to zenith and positive to horizontal direction, or in the local coordinate system (LCS), wherein estimated azimuth angle is measured relative to x-axis of LCS and positive in a counter-clockwise direction and estimated vertical angle is measured relative to z-axis of LCS and positive to x-y plane direction. The bearing, downtilt and slant angles. The sidelink AoA is determined at the UE antenna for a sidelink channel corresponding to this UE.

Additionally or alternatively, the above defined measurements may have associated quality metrics including timing, angular, line-of-sight (LOS)/non-line-of-sight (NLOS) indications using binary (hard indicator) or soft indicator values, e.g., range of probability values where a SL positioning measurement may be considered as LOS or NLOS. Such quality metrics can be requested to be reported along with the sidelink positioning measurement, using either lower layer or higher-layer signaling, e.g., SL Request Location Information SLPP/RSPP message. In addition to the first path reported for the above sidelink positioning measurements, additional subsequent paths may also be configured to be reported along with the sidelink positioning measurement, e.g., P paths out of a total Q received paths.

Additionally or alternatively, the sidelink PRS RSRP or RSRPP may be measured in conjunction with the aforementioned defined sidelink positioning measurements.

Additionally or alternatively, the initially transmitted SL-PRS may share the same or in other implementations, a different SL-PRS configuration as the reply SL-PRS, which implies, one of the following set of parameters may be the same/different symbol length, comb size, repetition information, e.g., repetition factor, periodicity, slot offset, RE offset, muting pattern, resource pool configuration, bandwidth, subcarrier spacing, cyclic prefix or the like.

In one or more implementations, in relation to the measurement of the SL-RSTD measurement, a reference anchor UE/node may be selected and configured amongst a group of anchor UEs/nodes. This selection may be based on a set of criteria, which may be configured or pre-configured. In addition, one or more of the following criteria may be used to select the reference anchor node: synchronization source; coarse/approximate priori location information of the anchor UEs/nodes; assigned transmission priority of Anchor UEs/nodes; SL interference measurements, e.g., CLI; received sidelink positioning/other reference signal strength measurements, e.g., SL PRS RSRP, SL PRS RSPP, SL RSSI, SL CR, SL CBR, PSBCH RSRP, PSSCH RSRP, PSCCH RSRP; and selecting best anchor node/UE based on the best overall Real time difference (RTD) quality

In one or more implementations, a reference anchor UE/node candidate list may be signaled to all anchor UEs/nodes by the configuration or positioning calculation entity. This list may comprise of all possible anchor reference nodes in decreasing order of priority. Additionally or alternatively, the candidate reference anchor UEs/nodes may be listed according to an increasing order of priority. In the event that a selected sidelink anchor node/UE is no longer connected to the target device/UE, due to, e.g., Radio Link Failure (RLF)/beam failure, out-of-coverage of the target-UE, a new reference anchor node may be selected from the reference anchor UE/node candidate list.

The reference candidate list may be received from higher-layers via PC5-S, PC5 RRC, SLPP/RSPP, e.g., SL Provide Assistance Data or SL Request Location Information message. Additionally or alternatively, the SL reference anchor node selection may originate from the same layer/protocol performing the anchor UE/node selection, implying that the anchor UE selection and reference anchor UE selection may be performed jointly.

In one or more implementations, the configuration entity comprising either a network entity, e.g., LMF, gNB, RSU or UE entity, e.g., other anchor UEs, sidelink positioning server UEs, SL-PRS configuration UE, target UE or the like may configure the RTD to the positioning calculation entity. The RTD information comprises of a set of time synchronization information elements between the reference anchor node/UE and each of the other anchor nodes/UEs in order for the positioning calculation entity to compensate for any synchronization errors.

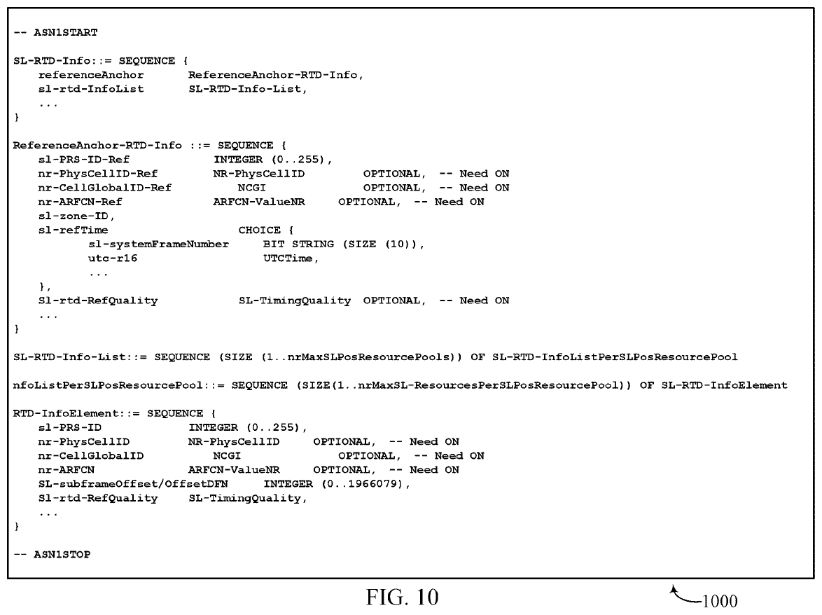

FIG. 10 illustrates an example of a SL-RTD information message 1000 as related to combined one-to-many and many-to-one sidelink positioning in accordance with aspects of the present disclosure. Fields of the SL-RTD information message 1000 are described below. In addition, further SL-TimingQuality is defined to provide a quality indicator of a sidelink timing value, e.g., in terms of uncertainty in meters or timing resolution which can expressed in varying degrees of quality such as 0.1, 1., 10, 30 meters.

The referenceTRP-RTD-Info field (or ReferenceAnchor-RTD-Info field) defines the reference anchor node/UE for the RTD and comprises the following sub-fields: sl-PRS-ID-Ref, nr-PhysCellId-Ref, nr-CellGlobalId-Ref, nr-ARFCN-Ref, sl-refTime, and sl-rtd-RefQuality.

The sl-PRS-ID-Ref field is used along with a SL Positioning Frequency Layer, SL BWP ID, SL Resource Pool ID, SL-PRS Resource Set ID and a SL-PRS Resources ID to uniquely identify a SL-PRS Resource, which belongs to the anchor node/UE.

The nr-PhysCellId-Ref field specifies the physical cell identity of the reference TRP.

The nr-CellGlobalId-Ref field specifies the NCGI, the globally unique identity of a cell in NR, of the reference TRP.

The nr-ARFCN-Ref field specifies the NR-ARFCN of the TRP's CD-SSB corresponding to nr-PhysCellID.

The sl-refTime field specifies the reference time at which the sl-rtd-InfoList is valid. The sl-systemFrameNumber choice refers to the SL SFN of the reference anchor node/UE. Additionally or alternatively, this element could also refer the DFN offset as opposed to the SFN.

The sl-rtd-RefQuality field specifies the quality of the timing of reference anchor node/UE on the sidelink, used to determine the SL RTD values provided in sl-rtd-InfoList.

The sl-PRS-ID field is used along with a SL Positioning Frequency Layer, SL BWP ID, SL Resource Pool ID, SL-PRS Resource Set ID and a SL-PRS Resources ID to uniquely identify a SL-PRS Resource. This ID can be associated with multiple DL-PRS Resource Sets associated with a single TRP for which the RTD-InfoElement is applicable.

The sl-subframeOffset field specifies the subframe boundary offset at the anchor UE/node antenna location between the reference anchor node/UE and the other anchor node/UE in time units T_{c}=1/(Δfₘₐₓ·N_{f}) where Δfₘₐₓ=480·10³ Hz and N=4096. The offset is counted from the beginning of a subframe #0 of the reference anchor node/UE to the beginning of the closest subsequent subframe of this neighbor TRP. Scale factor 1 Tc.

The sl-rtd-Quality field specifies the quality of the RTD between each anchor node/UE and other anchor node/UE on the SL.

In one or more implementations, a separate SL-PRS configuration may be signaled to the one or more reference anchor nodes/UEs.

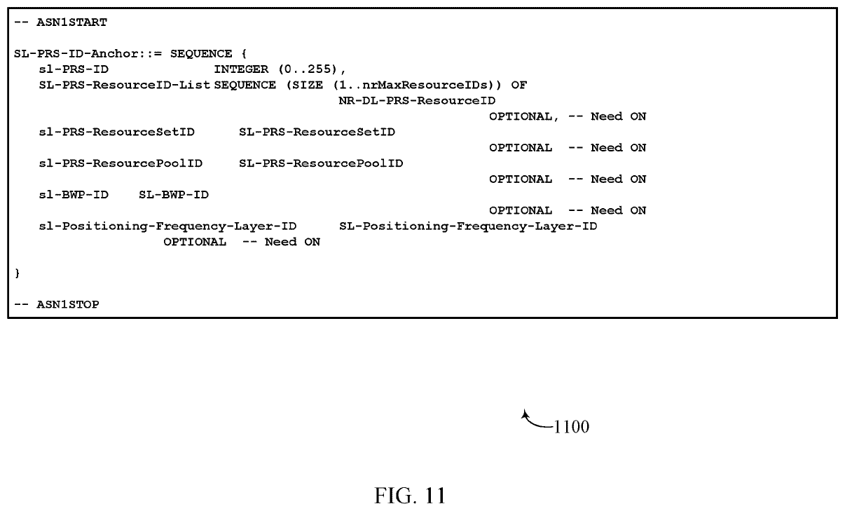

FIG. 11 illustrates an example of a SL-PRS configuration message 1100 as related to combined one-to-many and many-to-one sidelink positioning in accordance with aspects of the present disclosure.

The messages 1000 and 1100 illustrated in FIGS. 10 and 11 may be signaled using higher-layer signaling such as PC5-S, PC5 RRC, or SLPP/RSPP, e.g., using a SL Provide Assistance Data message. Additionally or alternatively, such messages may also be signaled using lower layer signaling such as SCI, MAC-CE if applicable.

In one or more implementations, the anchor UEs/nodes are provided with an expected search window in which to measure the SL-PRS for the SL-RTOA measurement. This can be as a function of the expected propagation delay expressed relative to the SL-RTOA reference time as described in above in terms of T₀ and t_{SL-PRS}. This window is especially configured to measure the RTOA or any other related TOA/Timing advance measurement.

Additionally or alternatively, the delay uncertainty associated to the expected propagation delay may be also signaled to the anchor UEs/nodes and may be as function of the sampling time, e.g., Ts=1/(15.10³.2048).

This SL-RTOA expected search window and associated uncertainty may be signaled using higher-layer signaling such as PC5-S, PC5 RRC, or SLPP/RSPP, e.g., using a SL Provide Assistance Data message. Additionally or alternatively, such messages may also be signaled using lower layer signaling such as SCI, MAC-CE if applicable.

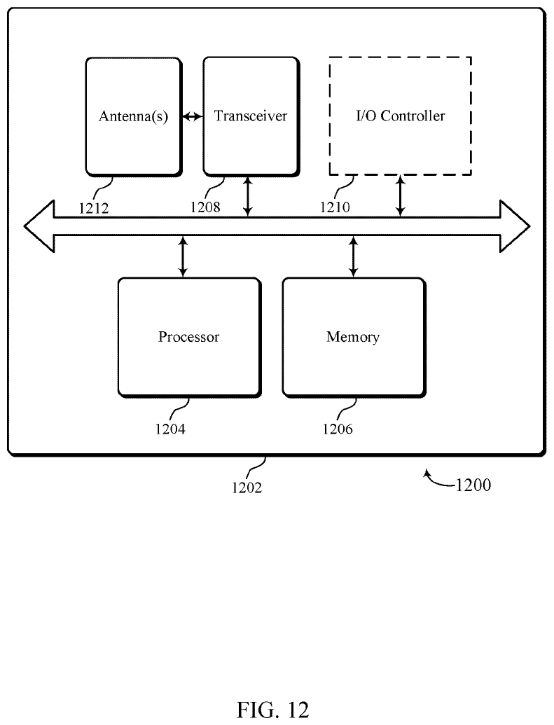

FIG. 12 illustrates an example of a block diagram 1200 of a device 1202 that supports combined one-to-many and many-to-one sidelink positioning in accordance with aspects of the present disclosure. The device 1202 may be an example of a target device (e.g., a UE 104) as described herein. The device 1202 may support wireless communication with one or more network entities 102, UEs 104, or any combination thereof. The device 1202 may include components for bi-directional communications including components for transmitting and receiving communications, such as a processor 1204, a memory 1206, a transceiver 1208, and an I/O controller 1210. These components may be in electronic communication or otherwise coupled (e.g., operatively, communicatively, functionally, electronically, electrically) via one or more interfaces (e.g., buses).

The processor 1204, the memory 1206, the transceiver 1208, or various combinations thereof or various components thereof may be examples of means for performing various aspects of the present disclosure as described herein. For example, the processor 1204, the memory 1206, the transceiver 1208, or various combinations or components thereof may support a method for performing one or more of the operations described herein.

In some implementations, the processor 1204, the memory 1206, the transceiver 1208, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1204 and the memory 1206 coupled with the processor 1204 may be configured to perform one or more of the functions described herein (e.g., executing, by the processor 1204, instructions stored in the memory 1206).

For example, the processor 1204 may support wireless communication at the device 1202 in accordance with examples as disclosed herein. Processor 1204 may be configured as or otherwise support to: receive, from a first set of devices, first signalings indicating a first set of SL-PRSs transmitted in a many-to-one manner; generate a first set of positioning measurements based on the first set of SL-PRSs; transmit, to the first set of devices in response to the receiving the first set of SL-PRSs, second signalings indicating an additional SL-PRS in a one-to-many manner; receive, from the first set of devices, third signalings indicating a second set of positioning measurements; transmit a fourth signaling indicating a measurement report including the first set of positioning measurements and the second set of positioning measurements.

Additionally or alternatively, the processor 1204 may be configured to or otherwise support: to cause the apparatus to transmit, to the first set of devices in response to receiving the first set of SL-PRSs, fifth signalings indicating a SL-PRS measurement report; where the apparatus comprises a target UE and the first set of devices comprises one or more of an anchor UE, a sidelink positioning server UE, and a roadside unit; where each positioning measurement in the first set of positioning measurements and the second set of positioning measures comprises one or more of a sidelink reference signal time difference, a sidelink relative time of arrival, a user equipment receive-transmit time difference, a sidelink angle-of-arrival, a sidelink reference signal received power, and a sidelink reference signal received path power; where the sidelink reference signal time difference measurement is defined as a sidelink relative timing difference between a TP of an anchor device j and a reference TP of an anchor device i, defined as T_{SubframeRx,j}−T_{SubframeRx,i}, where: the T_{SubframeRx,j} is a time when the user equipment receives a start of one subframe from the TP of the anchor device j and the T_{SubframeRx,i} is a time when the user equipment receives a corresponding start of one subframe from the TP of the anchor device i that is closest in time to a subframe received from the TP of anchor device j; where the sidelink relative time of arrival measurement is defined as a beginning of a sidelink subframe i containing SL-PRS resources received at each of the first set of devices, relative to a SL-RTOA reference time, the SL-RTOA reference time further defined by T₀+t_{SL-PRS}, where T₀ is a nominal start time of a SFN 0 or a DFN 0 and t_{SL-PRS} is defined by (10n_{SL-F}+n_{SL-SF})×10-3, where nst-F and n_{SL-SF} represent the DFN and subframe number of the SL-PRS resources, respectively: where the user equipment receive-transmit time difference measurement is defined as a difference between a reception time of a SL-PRS and subsequent transmission time of another SL-PRS, defined by T_{UE-RX}-T_{UE-TX}, where the T_{UE-RX} is the user equipment received timing of a sidelink subframe #i from a sidelink device, defined by a first detected path in time and the T_{UE-TX} is defined as the user equipment transmit timing of a sidelink subframe #j that is closest in time to the subframe #i received from the sidelink device; to receive a fifth signaling indicating a configuration message to perform one-to-many SL-PRS transmission and many-to-one SL-PRS reception; where the configuration message comprises one or more of a sidelink positioning protocol message, a sidelink control information, a sidelink medium access control element, a PC5-RRC message, a PC5-S message, a vehicle-to-everything message, and a proximity services layer message; where the configuration message comprises a trigger including a SL-PRS cast type indicator indicating a transmission type for SL-PRS via 1st stage or 2nd stage sidelink control information (SCI), a transmission order of the SL-PRS, and a type of positioning technique to be performed; where the SL-PRS cast type indicator comprises one of a unicast, groupcast, one-to-many, many-to-one, or broadcast indication; where the one-to-many or many-to-one indication comprise a plurality of separate unicast signalings; where a triggering message to perform sidelink positioning comprises one or more of: a number of identified anchor devices, types of positioning methods, a transmission order indication of SL-PRS, user equipment identifiers of involved user equipments in a configured sidelink positioning session, cast-type indicators, an indication of a configured reference anchor device, synchronization information; where to transmit the second signalings is to transmit the second signalings in an order of transmission comprises first transmitting a first SL-PRS in a one-to-many manner and thereafter transmitting additional SL-PRSs in a many-to-one manner; to transmit the fourth signaling to one or more of a base station, a location management function, a roadside unit, a sidelink positioning server user equipment, and a sidelink positioning client user equipment; to receive a fifth signaling indicating a reference anchor device for generating the first set of positioning measurements, where the reference anchor device is one of the first set of devices; where the fifth signaling further indicates a SL-PRS identifier allowing a particular SL-PRS resource to be identified, a subframe boundary offset at a location of the anchor device between the reference anchor device and an additional device in the first set of devices, and a quality of real time difference between the reference anchor device and the additional device in the first set of devices.

For example, the processor 1204 may support wireless communication at the device 1202 in accordance with examples as disclosed herein. Processor 1204 may be configured as or otherwise support a means for receiving, from a first set of devices, first signalings indicating a first set of SL-PRSs transmitted in a many-to-one manner; generating a first set of positioning measurements based on the first set of SL-PRSs; transmitting, to the first set of devices in response to the receiving the first set of SL-PRSs, second signalings indicating an additional SL-PRS in a one-to-many manner; receiving, from the first set of devices, third signalings indicating a second set of positioning measurements; and transmitting a fourth signaling indicating a measurement report including the first set of positioning measurements and the second set of positioning measurements.

Additionally or alternatively, the processor 1204 may be configured to or otherwise support: transmitting, to the first set of devices in response to receiving the first set of SL-PRSs, fifth signalings indicating a SL-PRS measurement report; where the method is implemented by a target UE and the first set of devices comprises one or more of an anchor UE, a sidelink positioning server UE, and a roadside unit; where each positioning measurement in the first set of positioning measurements and the second set of positioning measures comprises one or more of a sidelink reference signal time difference, a sidelink relative time of arrival, a user equipment receive-transmit time difference, a sidelink angle-of-arrival, a sidelink reference signal received power, and a sidelink reference signal received path power; where the sidelink reference signal time difference measurement is defined as a sidelink relative timing difference between a transmission point (TP) of an anchor device j and a reference TP of an anchor device i, defined as T_{SubframeRx,j}−T_{SubframeRx,i}, where: the T_{SubframeRx,j} is a time when the user equipment receives a start of one subframe from the TP of the anchor device j and the T_{SubframeRx,i} is a time when the user equipment receives a corresponding start of one subframe from the TP of the anchor device i that is closest in time to a subframe received from the TP of anchor device j; where the sidelink relative time of arrival measurement is defined as a beginning of a sidelink subframe i containing SL-PRS resources received at each of the first set of devices, relative to a SL-RTOA reference time, the SL-RTOA reference time further defined by T₀+t_{SL-PRS}, where T₀ is a nominal start time of a SFN 0 or a DFN 0 and t_{SL-PRS} is defined by (10n_{SL-F}+n_{SL-SF})×10⁻³, where n_{SL-F} and n_{SL-SF} represent the DFN and subframe number of the SL-PRS resources, respectively; where the user equipment receive-transmit time difference measurement is defined as a difference between a reception time of a SL-PRS and subsequent transmission time of another SL-PRS, defined by T_{UE-RX}-T_{UE-TX}, where the T_{UE-RX} is the user equipment received timing of a sidelink subframe #i from a sidelink device, defined by a first detected path in time and the T_{UE-TX} is defined as the user equipment transmit timing of a sidelink subframe #j that is closest in time to the subframe #i received from the sidelink device; further including receiving a fifth signaling indicating a configuration message to perform one-to-many SL-PRS transmission and many-to-one SL-PRS reception; where the configuration message comprises one or more of a sidelink positioning protocol message, a sidelink control information, a sidelink medium access control element, a PC5-RRC message, a PC5-S message, a vehicle-to-everything message, and a proximity services layer message; where the configuration message comprises a trigger including a SL-PRS cast type indicator indicating a transmission type for SL-PRS via 1^{st} stage or 2^{nd} stage sidelink control information (SCI), a transmission order of the SL-PRS, and a type of positioning technique to be performed; where the SL-PRS cast type indicator comprises one of a unicast, groupcast, one-to-many, many-to-one, or broadcast indication; where the one-to-many or many-to-one indication comprise a plurality of separate unicast signalings; where a triggering message to perform sidelink positioning comprises one or more of: a number of identified anchor devices, types of positioning methods, a transmission order indication of SL-PRS, user equipment identifiers of involved user equipments in a configured sidelink positioning session, cast-type indicators, an indication of a configured reference anchor device, synchronization information; where transmitting the second signalings comprises transmitting the second signalings in an order of transmission comprises first transmitting a first SL-PRS in a one-to-many manner and thereafter transmitting additional SL-PRSs in a many-to-one manner; further including transmitting the fourth signaling to one or more of a base station, a location management function, a roadside unit, a sidelink positioning server user equipment, and a sidelink positioning client user equipment; further including receiving a fifth signaling indicating a reference anchor device for generating the first set of positioning measurements, where the reference anchor device is one of the first set of devices; where the fifth signaling further indicates a SL-PRS identifier allowing a particular SL-PRS resource to be identified, a subframe boundary offset at a location of the anchor device between the reference anchor device and an additional device in the first set of devices, and a quality of real time difference between the reference anchor device and the additional device in the first set of devices.

The processor 1204 of the device 1202, such as a UE 104, may support wireless communication in accordance with examples as disclosed herein. The processor 1204 includes at least one controller coupled with at least one memory, and is configured to or operable to cause the processor to: receive, from a first set of devices, first signalings indicating a first set of SL-PRSs transmitted in a many-to-one manner; generate a first set of positioning measurements based on the first set of SL-PRSs; transmit, to the first set of devices in response to the receiving the first set of SL-PRSs, second signalings indicating an additional SL-PRS in a one-to-many manner; receive, from the first set of devices, third signalings indicating a second set of positioning measurements; transmit a fourth signaling indicating a measurement report including the first set of positioning measurements and the second set of positioning measurements.

The processor 1204 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1204 may be configured to operate a memory array using a memory controller. In some other implementations, a memory controller may be integrated into the processor 1204. The processor 1204 may be configured to execute computer-readable instructions stored in a memory (e.g., the memory 1206) to cause the device 1202 to perform various functions of the present disclosure.

The memory 1206 may include random access memory (RAM) and read-only memory (ROM). The memory 1206 may store computer-readable, computer-executable code including instructions that, when executed by the processor 1204 cause the device 1202 to perform various functions described herein. The code may be stored in a non-transitory computer-readable medium such as system memory or another type of memory. In some implementations, the code may not be directly executable by the processor 1204 but may cause a computer (e.g., when compiled and executed) to perform functions described herein. In some implementations, the memory 1206 may include, among other things, a basic I/O system (BIOS) which may control basic hardware or software operation such as the interaction with peripheral components or devices.

The I/O controller 1210 may manage input and output signals for the device 1202. The I/O controller 1210 may also manage peripherals not integrated into the device M02. In some implementations, the I/O controller 1210 may represent a physical connection or port to an external peripheral. In some implementations, the I/O controller 1210 may utilize an operating system such as iOS®, ANDROID®, MS-DOS®, MS-WINDOWS®, OS/2®, UNIX®, LINUX®, or another known operating system. In some implementations, the I/O controller 1210 may be implemented as part of a processor, such as the processor 1204. In some implementations, a user may interact with the device 1202 via the I/O controller 1210 or via hardware components controlled by the I/O controller 1210.

In some implementations, the device 1202 may include a single antenna 1212. However, in some other implementations, the device 1202 may have more than one antenna 1212 (i.e., multiple antennas), including multiple antenna panels or antenna arrays, which may be capable of concurrently transmitting or receiving multiple wireless transmissions. The transceiver 1208 may communicate bi-directionally, via the one or more antennas 1212, wired, or wireless links as described herein. For example, the transceiver 1208 may represent a wireless transceiver and may communicate bi-directionally with another wireless transceiver. The transceiver 1208 may also include a modem to modulate the packets, to provide the modulated packets to one or more antennas 1212 for transmission, and to demodulate packets received from the one or more antennas 1212.

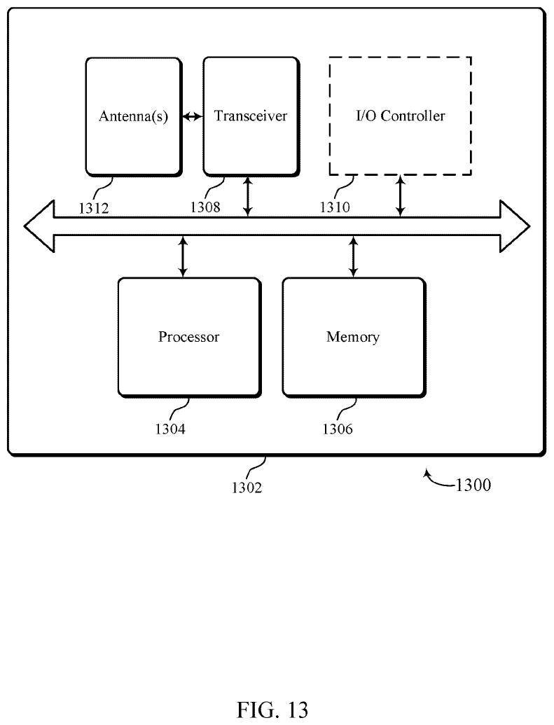

FIG. 13 illustrates an example of a block diagram 1300 of a device 1302 that supports combined one-to-many and many-to-one sidelink positioning in accordance with aspects of the present disclosure. The device 1302 may be an example of an anchor device (e.g., a UE 104) as described herein. The device 1302 may support wireless communication with one or more network entities 102, UEs 104, or any combination thereof. The device 1302 may include components for bi-directional communications including components for transmitting and receiving communications, such as a processor 1304, a memory 1306, a transceiver 1308, and an I/O controller 1310. These components may be in electronic communication or otherwise coupled (e.g., operatively, communicatively, functionally, electronically, electrically) via one or more interfaces (e.g., buses).

The processor 1304, the memory 1306, the transceiver 1308, or various combinations thereof or various components thereof may be examples of means for performing various aspects of the present disclosure as described herein. For example, the processor 1304, the memory 1306, the transceiver 1308, or various combinations or components thereof may support a method for performing one or more of the operations described herein.

In some implementations, the processor 1304, the memory 1306, the transceiver 1308, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1304 and the memory 1306 coupled with the processor 1304 may be configured to perform one or more of the functions described herein (e.g., executing, by the processor 1304, instructions stored in the memory 1306).

For example, the processor 1304 may support wireless communication at the device 1302 in accordance with examples as disclosed herein. Processor 1304 may be configured as or otherwise support to: transmit, to a first device in a many-to-one manner, a first signaling indicating a first SL-PRS; receive, from the first device in a one-to-many manner in response to the first SL-PRS, a second signaling indicating a second SL-PRS; generate a first positioning measurement based on the second SL-PRS; transmit a third signaling indicating a third SL-PRS or a measurement report including the first positioning measurement.

Additionally or alternatively, the processor 1304 may be configured to or otherwise support: to cause the apparatus to receive, from the first device, a fourth signaling indicating a SL-PRS measurement report; where the first device comprises a target UE and the apparatus comprises one or more of an anchor UE, a sidelink positioning server UE, and a roadside unit; where the first positioning measurement comprises one or more of a sidelink reference signal time difference, a sidelink relative time of arrival, a user equipment receive-transmit time difference, a sidelink angle-of-arrival, a sidelink reference signal received power, and a sidelink reference signal received path power; where the processor is further configured to cause the apparatus to receive a fourth signaling indicating a configuration message to perform one-to-many SL-PRS reception and many-to-one SL-PRS transmission; where the configuration message comprises one or more of a sidelink positioning protocol message, a PC5-RRC message, a PC5-S message, a vehicle-to-everything message, and a proximity services layer message; where the configuration message comprises a trigger including a SL-PRS cast type indicator indicating a transmission type for SL-PRS via 1st stage or 2nd stage sidelink control information (SCI), a transmission order of the SL-PRS, and a type of positioning technique to be performed; where the SL-PRS cast type indicator comprises one of a unicast, groupcast, one-to-many, many-to-one, or broadcast indication; to transmit the third signaling to one or more of a base station, a location management function, a roadside unit, a sidelink positioning server user equipment, a sidelink positioning client user equipment, and the first device; to receive a fourth signaling indicating that the apparatus is a reference anchor for the first device to generate a set of positioning measurements; to receive a fourth signaling indicating one or both of a search window or a search window quality indicator in which to expect the second signaling.

For example, the processor 1304 may support wireless communication at the device 1302 in accordance with examples as disclosed herein. Processor 1304 may be configured as or otherwise support a means for transmitting, to a first device in a many-to-one manner, a first signaling indicating a first SL-PRS; receiving, from the first device in a one-to-many manner in response to the first SL-PRS, a second signaling indicating a second SL-PRS; generating a first positioning measurement based on the second SL-PRS; and transmitting a third signaling indicating a third SL-PRS or a measurement report including the first positioning measurement.

Additionally or alternatively, the processor 1304 may be configured to or otherwise support: receiving, from the first device, a fourth signaling indicating a SL-PRS measurement report; where the first device comprises a target UE and the method is implemented by one or more of an anchor UE, a sidelink positioning server UE, and a roadside unit; where the first positioning measurement comprises one or more of a sidelink reference signal time difference, a sidelink relative time of arrival, a user equipment receive-transmit time difference, a sidelink angle-of-arrival, a sidelink reference signal received power, and a sidelink reference signal received path power; receiving a fourth signaling indicating a configuration message to perform one-to-many SL-PRS reception and many-to-one SL-PRS transmission; where the configuration message comprises one or more of a sidelink positioning protocol message, a PC5-RRC message, a PC5-S message, a vehicle-to-everything message, and a proximity services layer message; where the configuration message comprises a trigger including a SL-PRS cast type indicator indicating a transmission type for SL-PRS via 1st stage or 2nd stage sidelink control information (SCI), a transmission order of the SL-PRS, and a type of positioning technique to be performed; where the SL-PRS cast type indicator comprises one of a unicast, groupcast, one-to-many, many-to-one, or broadcast indication; transmitting the third signaling to one or more of a base station, a location management function, a roadside unit, a sidelink positioning server user equipment, a sidelink positioning client user equipment, and the first device; receiving a fourth signaling indicating that an apparatus implementing the method is a reference anchor for the first device to generate a set of positioning measurements; receiving a fourth signaling indicating one or both of a search window or a search window quality indicator in which to expect the second signaling.

The processor 1304 of the device 1302, such as a UE 104, may support wireless communication in accordance with examples as disclosed herein. The processor 1304 includes at least one controller coupled with at least one memory, and is configured to or operable to cause the processor to: transmit, to a first device in a many-to-one manner, a first signaling indicating a first SL-PRS; receive, from the first device in a one-to-many manner in response to the first SL-PRS, a second signaling indicating a second SL-PRS; generate a first positioning measurement based on the second SL-PRS; transmit a third signaling indicating a third SL-PRS or a measurement report including the first positioning measurement.

The processor 1304 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1304 may be configured to operate a memory array using a memory controller. In some other implementations, a memory controller may be integrated into the processor 1304. The processor 1304 may be configured to execute computer-readable instructions stored in a memory (e.g., the memory 1306) to cause the device 1302 to perform various functions of the present disclosure.

The memory 1306 may include random access memory (RAM) and read-only memory (ROM). The memory 1306 may store computer-readable, computer-executable code including instructions that, when executed by the processor 1304 cause the device 1302 to perform various functions described herein. The code may be stored in a non-transitory computer-readable medium such as system memory or another type of memory. In some implementations, the code may not be directly executable by the processor 1304 but may cause a computer (e.g., when compiled and executed) to perform functions described herein. In some implementations, the memory 1306 may include, among other things, a basic I/O system (BIOS) which may control basic hardware or software operation such as the interaction with peripheral components or devices.

The I/O controller 1310 may manage input and output signals for the device 1302. The I/O controller 1310 may also manage peripherals not integrated into the device M02. In some implementations, the I/O controller 1310 may represent a physical connection or port to an external peripheral. In some implementations, the I/O controller 1310 may utilize an operating system such as iOS®, ANDROID®, MS-DOS®, MS-WINDOWS®, OS/2®, UNIX®, LINUX®, or another known operating system. In some implementations, the I/O controller 1310 may be implemented as part of a processor, such as the processor 1304. In some implementations, a user may interact with the device 1302 via the I/O controller 1310 or via hardware components controlled by the I/O controller 1310.

In some implementations, the device 1302 may include a single antenna 1312. However, in some other implementations, the device 1302 may have more than one antenna 1312 (i.e., multiple antennas), including multiple antenna panels or antenna arrays, which may be capable of concurrently transmitting or receiving multiple wireless transmissions. The transceiver 1308 may communicate bi-directionally, via the one or more antennas 1312, wired, or wireless links as described herein. For example, the transceiver 1308 may represent a wireless transceiver and may communicate bi-directionally with another wireless transceiver. The transceiver 1308 may also include a modem to modulate the packets, to provide the modulated packets to one or more antennas 1312 for transmission, and to demodulate packets received from the one or more antennas 1312.

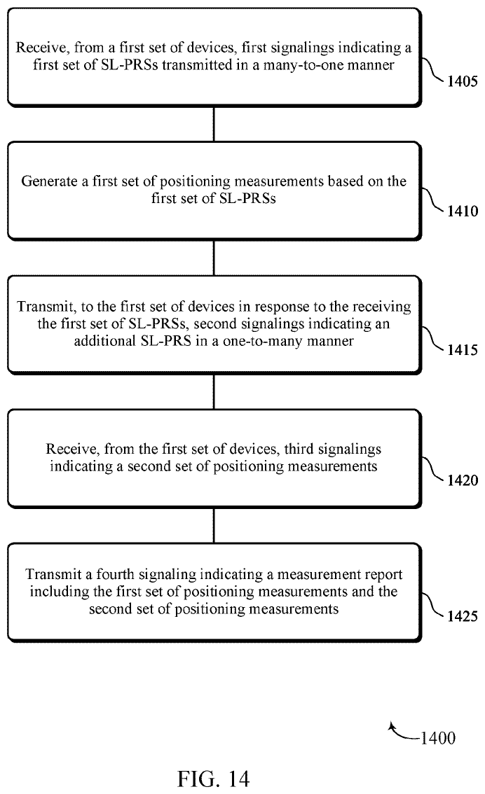

FIG. 14 illustrates a flowchart of a method 1400 that supports combined one-to-many and many-to-one sidelink positioning in accordance with aspects of the present disclosure. The operations of the method 1400 may be implemented by a device or its components as described herein. For example, the operations of the method 1400 may be performed by a UE 104 (e.g., a target UE) as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1405, the method may include receiving, from a first set of devices, first signalings indicating a first set of SL-PRSs transmitted in a many-to-one manner. The operations of 1405 may be performed in accordance with examples as described herein. In some implementations, aspects of the operations of 1405 may be performed by a device as described with reference to FIG. 1.

At 1410, the method may include generating a first set of positioning measurements based on the first set of SL-PRSs. The operations of 1410 may be performed in accordance with examples as described herein. In some implementations, aspects of the operations of 1410 may be performed by a device as described with reference to FIG. 1.

At 1415, the method may include transmitting, to the first set of devices in response to the receiving the first set of SL-PRSs, second signalings indicating an additional SL-PRS in a one-to-many manner. The operations of 1415 may be performed in accordance with examples as described herein. In some implementations, aspects of the operations of 1415 may be performed by a device as described with reference to FIG. 1.

At 1420, the method may include receiving, from the first set of devices, third signalings indicating a second set of positioning measurements. The operations of 1420 may be performed in accordance with examples as described herein. In some implementations, aspects of the operations of 1420 may be performed by a device as described with reference to FIG. 1.

At 1425, the method may include transmitting a fourth signaling indicating a measurement report including the first set of positioning measurements and the second set of positioning measurements. The operations of 1425 may be performed in accordance with examples as described herein. In some implementations, aspects of the operations of 1425 may be performed by a device as described with reference to FIG. 1.

FIG. 15 illustrates a flowchart of a method 1500 that supports combined one-to-many and many-to-one sidelink positioning in accordance with aspects of the present disclosure. The operations of the method 1500 may be implemented by a device or its components as described herein. For example, the operations of the method 1500 may be performed by a UE 104 (e.g., a target UE) as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1505, the method may include receiving a fifth signaling indicating a configuration message to perform one-to-many SL-PRS transmission and many-to-one SL-PRS reception. The operations of 1505 may be performed in accordance with examples as described herein. In some implementations, aspects of the operations of 1505 may be performed by a device as described with reference to FIG. 1.

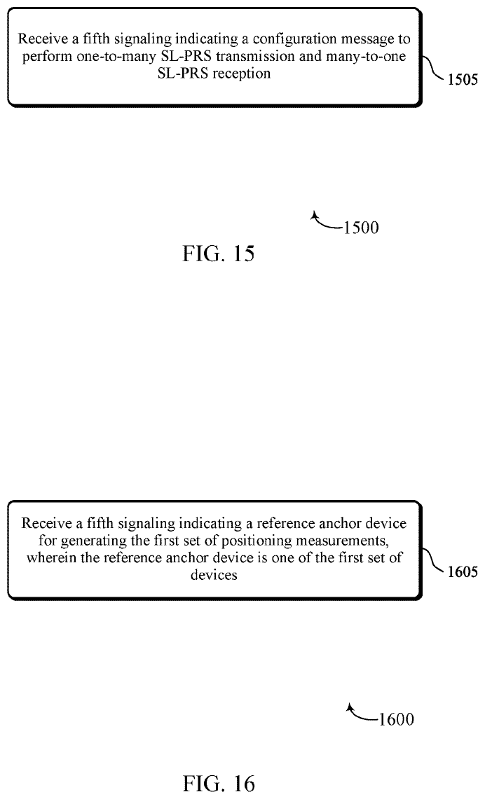

FIG. 16 illustrates a flowchart of a method 1600 that supports combined one-to-many and many-to-one sidelink positioning in accordance with aspects of the present disclosure. The operations of the method 1600 may be implemented by a device or its components as described herein. For example, the operations of the method 1600 may be performed by a UE 104 (e.g., a target UE) as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1605, the method may include receiving a fifth signaling indicating a reference anchor device for generating the first set of positioning measurements, wherein the reference anchor device is one of the first set of devices. The operations of 1605 may be performed in accordance with examples as described herein. In some implementations, aspects of the operations of 1605 may be performed by a device as described with reference to FIG. 1.

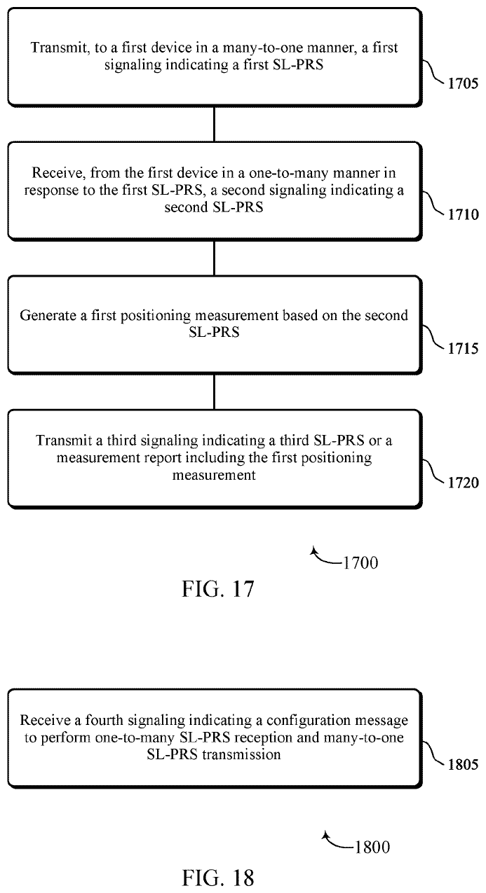

FIG. 17 illustrates a flowchart of a method 1700 that supports combined one-to-many and many-to-one sidelink positioning in accordance with aspects of the present disclosure. The operations of the method 1700 may be implemented by a device or its components as described herein. For example, the operations of the method 1700 may be performed by UE 104 (e.g., an anchor UE) as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1705, the method may include transmitting, to a first device in a many-to-one manner, a first signaling indicating a first SL-PRS. The operations of 1705 may be performed in accordance with examples as described herein. In some implementations, aspects of the operations of 1705 may be performed by a device as described with reference to FIG. 1.

At 1710, the method may include receiving, from the first device in a one-to-many manner in response to the first SL-PRS, a second signaling indicating a second SL-PRS. The operations of 1710 may be performed in accordance with examples as described herein. In some implementations, aspects of the operations of 1710 may be performed by a device as described with reference to FIG. 1.

At 1715, the method may include generating a first positioning measurement based on the second SL-PRS. The operations of 1715 may be performed in accordance with examples as described herein. In some implementations, aspects of the operations of 1715 may be performed by a device as described with reference to FIG. 1.

At 1720, the method may include transmitting a third signaling indicating a third SL-PRS or a measurement report including the first positioning measurement. The operations of 1720 may be performed in accordance with examples as described herein. In some implementations, aspects of the operations of 1720 may be performed by a device as described with reference to FIG. 1.

FIG. 18 illustrates a flowchart of a method 1800 that supports combined one-to-many and many-to-one sidelink positioning in accordance with aspects of the present disclosure. The operations of the method 1800 may be implemented by a device or its components as described herein. For example, the operations of the method 1800 may be performed by UE 104 (e.g., an anchor UE) as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1805, the method may include receiving a fourth signaling indicating a configuration message to perform one-to-many SL-PRS reception and many-to-one SL-PRS transmission. The operations of 1805 may be performed in accordance with examples as described herein. In some implementations, aspects of the operations of 1805 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
generate a first set of positioning measurements based at least in part on a first set of sidelink positioning reference signals (SL-PRSs), wherein a first type of transmission associated with the first set SL-PRSs comprises unicast;
transmit, based at least in part on the first set of SL-PRSs, an indication of an additional SL-PRS, wherein a second type of transmission associated with the additional SL-PRS comprises groupcast;
receive a second set of positioning measurements;
transmit a measurement report including the first set of positioning measurements and the second set of positioning measurements.

2. The UE of claim 1, wherein the at least one processor is further configured to cause the UE to transmit a SL-PRS measurement report.

3. (canceled)

4. The UE of claim 1, wherein each positioning measurement in the first set of positioning measurements and the second set of positioning measures comprises one or more of a sidelink reference signal time difference, a sidelink relative time of arrival, a UE receive-transmit time difference, a sidelink angle-of-arrival, a sidelink reference signal received power, or a sidelink reference signal received path power.

5. The UE of claim 4, wherein the sidelink reference signal time difference measurement is a sidelink relative timing difference between a device j and a reference device i, defined as T_{SubframeRx,j}−T_{SubframeRx,i}, where the T_{SubframeRx,j} is a time when the UE receives a start of one subframe from the device j and the T_{SubframeRx,i} is a time when the UE receives a corresponding start of one subframe from the device i that is closest in time to a subframe received from the device j.

6. The UE of claim 4, wherein the sidelink relative time of arrival measurement is defined as a beginning of a sidelink subframe i containing SL-PRS resources received at each of a first set of devices, relative to a sidelink relative time of arrival (SL-RTOA) reference time, wherein the SL-RTOA reference time is further defined by T₀+t_{SL-PRS}, where T₀ is a nominal start time of a system frame number (SFN) 0 or a direct frame number (DFN) 0 and t_{SL-PRS} is defined by (10n_{SL-F}+N_{SL-SF})×10⁻³, where n_{SL-F} and n_{SL-SF} represent the DFN and subframe number of the SL-PRS resources, respectively.

7. The UE of claim 4, wherein the UE receive-transmit time difference measurement is a difference between a reception time of a SL-PRS and a subsequent transmission time of another SL-PRS, defined by T_{UE-RX}−T_{UE-TX}, where the T_{UE-RX} is the UE received timing of a sidelink subframe #i from a sidelink device, defined by a first detected path in time and the T_{UE-TX} is defined as a UE transmit timing of a sidelink subframe #j that is closest in time to the subframe #i received from the sidelink device.

8. The UE of claim 1, wherein the at least one processor is further configured to cause the UE to receive a configuration message to perform one-to-many SL-PRS transmission and many-to-one SL-PRS reception.

9. The UE of claim 8, wherein the configuration message comprises one or more of a sidelink positioning protocol message, a sidelink control information, a sidelink medium access control element, a PC5-RRC message, a PC5-S message, a vehicle-to-everything message, and a proximity services layer message.

10. The UE of claim 8, wherein the configuration message comprises a trigger including a SL-PRS cast type indicator indicating a transmission type for SL-PRS via 1^{st} stage or 2^{nd} stage sidelink control information (SCI), a transmission order of the SL-PRS, and a type of positioning technique to be performed.

11. The UE of claim 10, wherein the SL-PRS cast type indicator comprises one of a unicast indication, a groupcast indication, a one-to-many indication, a many-to-one indication, or a broadcast indication.

12. The UE of claim 11, wherein the one-to-many indication or the many-to-one indication comprises a plurality of separate unicast signalings.

13. The UE of claim 1, wherein the at least one processor is further configured to cause the UE to receive a triggering message to perform sidelink positioning, wherein the triggering message to perform sidelink positioning comprises one or more of a number of identified anchor devices, types of positioning methods, a transmission order indication of SL-PRS, UE identifiers of involved UEs in a configured sidelink positioning session, cast-type indicators, an indication of a configured reference anchor device, or synchronization information.

14. The UE of claim 1, wherein to transmit the indication of the additional SL-PRS, the at least one processor is further configured to cause the UE to transmit the indication of the additional SL-PRS in an order of transmission that comprises first transmitting a first SL-PRS in a one-to-many manner and thereafter transmitting additional SL-PRSs in a many-to-one manner.

15. The UE of claim 1, wherein to transmit the measurement report, the at least one processor is further configured to cause the UE to transmit the measurement report to one or more of a base station, a location management function, a roadside unit, a sidelink positioning server UE, or a sidelink positioning client UE.

16. The UE of claim 1, wherein the at least one processor is further configured to cause the UE to receive an indication of a reference anchor device for generating the first set of positioning measurements.

17. The UE of claim 16, wherein the indication of the reference anchor device further indicates a SL-PRS identifier allowing a particular SL-PRS resource to be identified, a subframe boundary offset at a location of the anchor device between the reference anchor device and one other device, and a quality of real time difference between the reference anchor device and the other device.

18. An apparatus for wireless communication, comprising:
at least one memory; and
at least one processor coupled with the at least one memory and configured to cause the apparatus to:
transmit a first sidelink positioning reference signal (SL-PRS), wherein a first type of transmission associated with the first SL-PRS comprises unicast;
receive, based at least in part on the first SL-PRS, a second SL-PRS, wherein a second type of transmission associated with the second SL-PRS comprises groupcast;
generate a positioning measurement based at least in part on the second SL-PRS;
transmit an indication of a third SL-PRS or a measurement report including the positioning measurement.

19. (canceled)

20. (canceled)

21. A method performed by a user equipment (UE), the method comprising:
generating a first set of positioning measurements based at least in part on a first set of sidelink positioning reference signals (SL-PRSs), wherein a first type of transmission associated with the first set SL-PRSs comprises unicast;
transmitting, based at least in part on the first set of SL-PRSs, an indication of an additional SL-PRS, wherein a second type of transmission associated with the additional SL-PRSs comprises groupcast;
receiving a second set of positioning measurements;
transmitting a measurement report including the first set of positioning measurements and the second set of positioning measurements.

22. The method of claim 21, wherein each positioning measurement in the first set of positioning measurements and the second set of positioning measures comprises one or more of a sidelink reference signal time difference measurement, a sidelink relative time of arrival measurement, or a UE receive-transmit time difference.

23. A method performed by an apparatus, the method comprising:
transmitting a first sidelink positioning reference signal (SL-PRS), wherein a first type of transmission associated with the first SL-PRS comprises unicast;
receiving, based at least in part on the first SL-PRS, a second SL-PRS, wherein a second type of transmission associated with the second SL-PRS comprises groupcast;
generating a positioning measurement based at least in part on the second SL-PRS; and
transmitting an indication of a third SL-PRS or a measurement report including the first positioning measurement.
